(19) United States
(12) Patent Application Publication
(10) Pub. No.: US 2008/0222535 A1
(43) Pub. Date: Sep. 11, 2008

(54) Sports Matchmaker Systems

(76) Inventors: Kenneth L. Zrike, Sedona, AZ (US); Christopher A. Zrike, Sedona, AZ (US)

Correspondence Address: Stoneman Volk Patent Group, 3770 NORTH 7TH STREET, Suite 100, PHOENIX, AZ, 85014, US

(21) Appl. No.: 12/047,299

(22) Filed: Mar. 12, 2008

Related U.S. Application Data
(63) Continuation-in-part of application No. 11/463,574, filed on Aug. 9, 2006.
(60) Provisional application No. 60/894,668, filed on Mar. 13, 2007.
(60) Provisional application No. 60/942,432, filed on Jun. 6, 2007.
(60) Provisional application No. 60/707,889, filed on Aug. 12, 2005.
(60) Provisional application No. 60/775,920, filed on Feb. 22, 2006.

(51) Int. Cl. G06F 3/048

(52) U.S. Cl. 715/751

(57) ABSTRACT

The Sports Matchmaker System provides an improved method for arranging sporting events and non-sporting events between unacquainted people. It provides a system for matching persons publicly offering to participate in particular sporting or social events with other persons desiring to participate in similar sporting or social events. The system also provides various means for communicating between the offering party and the accepting party to complete the event. The system also provides methods for arranging event venues for sporting and social events.

### CROSS-REFERENCE TO RELATED APPLICATION

The present application is related to and claims priority from prior provisional application Ser. No. 60/894,668, filed Mar. 13, 2007, entitled “SPORTS MATCHMAKER SYSTEMS”, and is related to and claims priority from prior provisional application Ser. No. 60/942,432, filed Jun. 6, 2007, entitled “SPORTS MATCHMAKER SYSTEMS”, and is a continuation-in-part of prior nonprovisional utility application Ser. No. 11/463,574, filed Aug. 9, 2006, entitled “SPORTS MATCHMAKER SYSTEMS”, which is related to and claims priority to prior provisional application Ser. No. 60/707,889, filed Aug. 12, 2005, entitled “SPORTS MATCHMAKER SYSTEMS”, and prior provisional application Ser. No. 60/775,920, filed Feb. 22, 2006, entitled “SPORTS MATCHMAKER SYSTEMS”, and is related to International PCT application Serial Number PCT/US2006/031495, filed Aug. 10, 2006, entitled “SPORTS MATCHMAKER SYSTEMS”, the contents all of which are incorporated herein by this reference and are not admitted to be prior art with respect to the present invention by the mention in this cross-reference section.

### BACKGROUND

This invention relates to providing systems for arranging meetings between unacquainted people. More particularly, this invention relates to providing systems for matching persons and/or teams offering to participate in particular sporting or social events with persons and/or teams desiring to participate in similar sporting or social events.

The explosive diffusion of the Internet into countries such as the United States has been accompanied by the proliferation of Internet-based singles—as in unmarried or unattached people—matchmaking systems. These matchmaking systems are predominantly oriented toward single, meaning unmarried or unattached, men and women wishing to meet other single men and women, generally for the purpose of establishing a romantic relationship. The success of these matchmaking systems is demonstrated by the large number of Web sites devoted to matchmaking available on the Internet today. Examples of Internet-based dating systems include Match.com, eHarmony.com, and Kiss.com.

Typically, these matchmaking systems focus exclusively on unmarried and unattached people and their desire to meet each other. In other words, these matchmaking systems ignore the social networking needs of the remainder of the population desiring to meet or jointly participate in something other than a “date”. While it is possible to find someone interested in golf or tennis using these sites, it is not possible to search and find a person with whom to play a specific, or particular, game of golf or tennis on these matchmaking Web sites. As a result a very large group of people and activities are not able to socially network effectively through the Internet. For example, couples, children, and teams have no means to identify others wishing to participate in activities that are event oriented, i.e., events that are location, time and date dependent. For instance, a traveler wishing to play golf on a Saturday while away from home must rely on calling golf courses in the area to determine if there are any opportunities to join a group of golfers in a golf game. Conversely, this traveler must rely on the same methods to make an offer to play golf. Additionally, the traveler has no opportunity to get to know the other participants in advance.

Thus, a great need exists for a system capable of effectively permitting social networking for people by facilitating identification of others who desire to offer and accept participation in activities that are event (especially sporting) oriented using the Internet.

### OBJECTS AND FEATURES OF THE INVENTION

A primary object and feature of the present invention is to provide a system for matching persons making specific sporting and social event participation offers with persons desiring to participate in a specific sporting and social event.

It is a further object and feature of the present invention to provide such a system for permitting participants to post offers to participate in a particular sporting or social event.

It is a further object and feature of the present invention to provide such a system for permitting participants to search for individuals making an offer to participate in a particular sporting or social event.

It is a further object and feature of the present invention to provide such a system for permitting participants to search profiles of participants' sporting and social interests and related skill levels.

It is a further object and feature of the present invention to provide such a system for permitting participants to communicate with each other through a Web site.

It is a further object and feature of the present invention to provide such a system for permitting couples, kids and teams to post offers to participate in a particular sporting or social event.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method, relating to providing at least one unconfirmed, unscheduled proposed-event preference of at least one registered user, among a network of registered users of at least one Internet web site resulting in at least one confirmed, scheduled event, such method comprising the steps of: providing storage of personal contact information of a plurality of registered users of the Internet web site; providing storage of at least one unconfirmed, unscheduled proposed-event preference for at least one first registered user of the Internet web site; providing communicating such at least one unconfirmed, unscheduled proposed-event preference to at least one first registered-user-selected set of the plurality of registered users of the Internet web site; providing communicating participation interest in the at least one preferred, unconfirmed, and unscheduled proposed-event by at least one member of the at least one first registered-user-selected set to at least one other member of the at least one registered-user-selected set; providing approving interest by the at least one other member in participating in the at least one preferred, unconfirmed, unscheduled proposed-event; providing automatically scheduling and storing the at least one now-approved, confirmed, scheduled event; and providing automatically communicating details of such now confirmed, scheduled event to the at least one other member approving participation, the “approved participants”. Moreover, it provides such a method, wherein such step of communicating details of such now confirmed, scheduled event to approved participants comprises the step of displaying, for the benefit of at least one of the approved participants, details of the now confirmed, scheduled event. Additionally, it provides such a method, wherein such step of providing approving interest in participating in the at least one preferred, unconfirmed, unscheduled proposed-event by the communicating registered users comprises the step of providing notifying approval among registered users by way of at least one email message delivered by way of the Internet. Also, it provides such a method, wherein such step of providing approving interest in participating in the at least one preferred, unconfirmed, unscheduled proposed-event by the communicating registered users comprises the step of providing notifying approval among registered users by way of at least SMS message delivered over at least one telecommunications network. In addition, it provides such a method, wherein such step of automatically communicating details of such now confirmed, scheduled event to approved participants comprises providing communicating such details by way of at least one email message delivered by way of the Internet. And, it provides such a method, wherein such step of communicating details of such now confirmed, scheduled event to approved participants comprises the step of providing communicating such details by way of at least SMS message over at least one telecommunications network. Further, it provides such a method, further comprising the step of providing displaying elapsed confirmed, scheduled event after a date when such confirmed, scheduled event was intended to occur, the method, further comprising the step of providing limiting a number of approved participants that may participate in the at least one preferred, unconfirmed, unscheduled proposed-event. Even further, it provides such a method, further comprising the step of providing displaying, for the benefit of at least one registered user, at least one quantity of remaining approved participant openings relating to a particular registered-user proposed limit of a number of approved participants that may participate in the at least one preferred, unconfirmed, unscheduled proposed-event. Moreover, it provides such a method, according to claim 1, further comprising the step of providing displaying, for the benefit of at least one registered user, approved personal contact information of at least one confirmed participant that may participate in the now confirmed, scheduled event so that the confirmed registered users may further communicate regarding the now confirmed, scheduled event. Additionally, it provides such a method, further comprising the step of providing assisting non-disclosure of contact information of at least one first participant to another participant; and providing assisting non-disclosure of contact information of such at least one second participant to such first participant. Also, it provides such a method, according to claim 1, further comprising the step of providing gathering data relating to the confirmed, scheduled event from participants of the confirmed, schedule event after the date when such confirmed, scheduled event was intended to occur has elapsed. In addition, it provides such a computer program system, wherein such SMS messaging is assisted by coupling through at least one Internet Web site. And, it provides such a computer program system, wherein such SMS messaging is assisted by coupling through at least one Internet Web site. Further, it provides such a computer program system, wherein the step of providing approving interest by the at least one other member in participating in the at least one preferred, unconfirmed, unscheduled proposed-event comprises providing displaying at least one clickable hyperlink that when clicked once communicates approved interest to registered users of the at least one Internet web site. Even further, it provides such a computer program system, wherein the step of providing gathering data relating to the confirmed, scheduled event from participants of the confirmed, schedule event after the date when such confirmed, scheduled event was intended to occur has elapsed comprises the step of providing assisting input from participants of the confirmed, schedule event concerning behavioral profiling of at least one of the participants. Even further, it provides such a computer program system, further comprising the step of assisting compiling statistical data concerning such behavioral profiling of each of at least one of the participants. Even further, it provides such a computer program system, further comprising the step of assisting anonymous display of such statistical data. Even further, it provides such a computer program system, further comprising the step of providing displaying of such statistical data coupled to each participants profile page data.

In accordance with another preferred embodiment hereof, this invention provides a method, relating to providing at least one unconfirmed, unscheduled proposed-event preference of at least one registered user, among a network of registered users of at least one Internet web site resulting in at least one confirmed, scheduled event, such method comprising the steps of: providing storage of personal contact information of a plurality of registered users of the Internet web site; providing storage of at least one unconfirmed, unscheduled proposed-event preference for at least one first registered user of the Internet web site; providing communicating such at least one unconfirmed, unscheduled proposed-event preference to at least one first registered-user-selected set of the plurality of registered users of the Internet web site; providing communicating participation interest in the at least one preferred, unconfirmed, and unscheduled proposed-event by at least one member of the at least one first registered-user-selected set to at least one other member of the at least one registered-user-selected set; providing approving interest by the at least one other member in participating in the at least one preferred, unconfirmed, unscheduled proposed-event; providing automatically scheduling and storing the at least one now-approved, confirmed, scheduled event; and providing automatically communicating details of such now confirmed, scheduled event to the at least one other member approving participation, the “approved participants”; wherein such unscheduled proposed-event preference is sports related. Even further, it provides such a method, wherein such unscheduled proposed-event preference is sports team related.

In accordance with a preferred embodiment hereof, this invention provides a computer program system for an Internet computer system, relating to finding at least one proposed joint event for assisting displaying participant personal profile information of at least one first participant by at least one second participant with, comprising the steps of: searchably storing proposed-event information wherein such proposed-event information comprises at least at least one type of proposed joint event, at least one proposed geographic area for such proposed joint event, and at least one proposed time criterion for such at least one proposed joint event; permitting input on behalf of such at least one first participant of such at least one proposed joint event; searchably storing such participant personal profile information wherein such participant personal profile information comprises at least at least one unique identifier, such at least one type of such proposed joint event, such of at least one first skill level of such at least one type of proposed joint event, demographic information, and contact information; permitting input on behalf of such at least one first participant such participant personal profile information; permitting associating such entered proposed joint event with such entered participant personal profile information; permitting input on behalf of such at least one second participant first searchable criteria for proposed matching of such at least one proposed joint event; retrieving from such computer database such stored proposed-event information matching such first searchable criteria; and displaying such entered participant profile information associated with such retrieved proposed-event information. Moreover, it provides such a computer program system wherein such at least one type of proposed joint event comprises at least one sporting event. Additionally, it provides such a computer program system wherein at least one of such at least one first participant and such at least one second participant comprises at least one team. Also, it provides such a computer program system wherein at least one of such at least one first participant and such at least one second participant comprises at least one couple.

In addition, it provides such a computer program system further comprising the steps of: permitting input, on behalf of such at least one first participant, of at least one first skill level of such at least one type of proposed joint event; permitting input on behalf of such at least one second participant at least one second searchable criterion for proposed matching with such at least one skill level of such at least one type of proposed joint event; retrieving from such computer database such proposed-event information matching such second searchable criterion; and displaying such entered participant profile information associated with such retrieved proposed-event information. And, it provides such a computer program system further comprising the step of retrieving on behalf of such at least one first participant such proposed-event information from such computer database. Further, it provides such a computer program system further comprising the steps of: permitting input on behalf of such at least one second participant at least one third searchable criteria for proposed matching of such personal profile information; and retrieving from such computer database such personal profile information matching such third searchable criteria. Even further, it provides such a computer program system wherein such personal profile information further comprises at least two of the following: children information, participant background information, personality traits information; favorite foods information; preferred music information; and at least one image.

Moreover, it provides such a computer program system further comprising the steps of: searchably storing at least one bulletin board posting; permitting entry on behalf of such at least one first participant of such at least one bulletin board posting; associating such at least one such bulletin board posting with such at least one first participant; permitting input on behalf of such at least one second participant at least one fourth searchable criteria for proposed matching with such personal profile information; retrieving such at least one bulletin board posting associated with such personal profile information matching such fourth search criteria. Additionally, it provides such a computer program system wherein such fourth search criteria comprises: at least one type of proposed joint event, at least one proposed geographic area for such proposed joint event; and at least one proposed time criterion for such at least one proposed joint event. Also, it provides such a computer program system further comprising the step of assisting such at least one second participant to communicate with such at least one first participant. In addition, it provides such a computer program system wherein the step of assisting such at least one second participant to communicate with such at least one first participant comprises the steps of: assisting non-disclosure of first contact information of such first participant to such second participant; and assisting non-disclosure of second contact information of such second participant to such first participant. And, it provides such a computer program system wherein the step of assisting such at least one second participant to communicate with such at least one first participant is accomplished with text messaging on digital mobile phones.

In accordance with another preferred embodiment hereof, this invention provides a system relating to conducting business utilizing an Internet Web site comprising the steps of: providing at least one first searchable database adapted to contain proposed sporting event information; and receiving such proposed sporting event information from at least one first participant; providing at least one second searchable database adapted to contain participant personal profile information; receiving such participant personal profile information from such at least one first participant; permitting at least one second participant to describe first search criteria related to searching such at least one first searchable database; wherein such first search criteria comprise at least at least one type of proposed sporting event, at least one proposed geographic area related to such at least one proposed sporting event, and at least one proposed time frame related to such at least one proposed sporting event; retrieving such proposed sporting event information matching such first search criteria; and presenting to such at least one second participant such participant personal profile information from such at least one first participant. Further, it provides such a system further comprising the step of receiving Web site advertising revenue. Even further, it provides such a system wherein the step of receiving Web site advertising revenue comprises the steps of: offering Web site advertising to at least one advertiser; receiving at least one Web site advertisement from such at least one advertiser; receiving payment from such at least one advertiser; after such step of receiving payment, approving such at least one Web site advertisement; and displaying such approved such at least one Web site advertisement. Moreover, it provides such a system further comprising the step of permitting at least one of such at least one first participant and such at least one second participant to select at least one link to such at least one advertiser.

Additionally, it provides such a system wherein such at least one advertiser comprises at least one sporting venue. Also, it provides such a system further comprising the step of receiving membership fees. In addition, it provides such a system wherein the step of receiving membership fees comprises the step of receiving payment from at one of such at least one first participant and such at least one second participant. And, it provides such a system further comprising the steps of: offering at least one product for sale to at least one of such at least one first participant and such at least one second participant; and receiving payment from at least one of such at least one first participant and such at least one second participant. Further, it provides such a system further comprising the step of: promoting at least one group event for at least one of such at least one first participant and such at least one second participant with at least one event provider; charging each attending at least one of such at least one first participant and such at least one second participant at least one fee; and paying such at least one event provider. Even further, it provides such a system further comprising the steps of: permitting at least one of such at least one first participant and such at least one second participant to select at least one link to such at least one travel provider; and receiving referral payments from such at least one travel provider. Moreover, it provides such a system further comprising the steps of: promoting at least one reality television program with at least one reality television program provider; and accepting at least one offer to participate in such at least one reality television program from at one of such at least one first participant and such at least one second participant.

Additionally, it provides such a system further comprising the step of assisting communication between such at least one first participant and such at least one second participant. Also, it provides such a system further comprising the step of offering payment to least one affiliate for referral of at least one new participant. In addition, it provides such a system further comprising the steps of: permitting such at least one second participant to describe second search criteria related to searching such at least one second searchable database; and permitting such at least one second participant to view such personal profile information matching such second search criteria. And, it provides such a system further comprising the steps of: providing at least one third searchable database adapted to contain bulletin board message information; receiving such bulletin board message information from such at least one first participant; permitting such at least one second participant to describe third search criteria related to searching such at least one third searchable database in combination with such at least one second searchable database; permitting such at least one second participant to view such bulletin board message information matching such third search criteria; and permitting such at least one second participant to view such participant personal profile information related to such at least one first participant.

In accordance with another preferred embodiment hereof, this invention provides a computer program system for an Internet computer system, relating to assisting finding at least one first participant by at least one second participant, comprising the steps of: searchably storing participant personal profile information wherein such participant personal profile information comprises at least at least one unique identifier, demographic information, contact information, permitting input on behalf of such at least one first participant such personal profile information; searchably storing at least one bulletin board posting; permitting entry on behalf of such at least one first participant of such at least one bulletin board posting; and associating such at least one such bulletin board posting with such at least one first participant. Further, it provides such a computer program system further comprising the steps of: permitting input on behalf of such at least one second participant at least one first searchable criteria for proposed matching with such personal profile information in combination with such bulletin board posting; and retrieving such at least one bulletin board posting associated with such personal profile information matching such search criteria. Even further, it provides such a computer program system further comprising the steps of: permitting input on behalf of such at least one second participant at least one second searchable criteria for proposed matching of such personal profile information; and retrieving from such computer database such first personal profile information matching such third searchable criteria. Even further, it provides such a computer program system wherein at least one of such at least one first participant and such at least one second participant comprises at least one team.

Even further, it provides such a computer program system wherein at least one of such at least one first participant and such at least one second participant comprises at least one couple. Even further, it provides such a computer program system wherein such personal profile information further comprises at least two of the following: marital status information children information, participant background information, personality traits information; favorite foods information; preferred music information; and at least one image. Even further, it provides such a computer program system further comprising the step of assisting such at least one second participant to communicate with such at least one first participant. Even further, it provides such a computer program system wherein the step of assisting such at least one second participant to communicate with such at least one first participant comprises the steps of: assisting non-disclosure of first contact information of such first participant to such second participant; and assisting non-disclosure of second contact information of such second participant to such first participant. Even further, it provides such a computer program system wherein the step of assisting such at least one second participant to communicate with such at least one first participant is accomplished with text messaging on digital mobile phones.

In accordance with a preferred embodiment hereof, this invention provides an Internet computer system, relating to assisting finding of at least one proposed joint event by at least one second participant with at least one first participant, comprising: computer database means for searchably storing proposed-event information wherein such proposed-event information comprises at least at least one type of proposed joint event, at least one proposed geographic area for such proposed joint event, and at least one proposed time frame for such at least one proposed joint event; computer interface means for permitting database entry on behalf of such at least one first participant of such at least one proposed joint event; computer interface means for permitting entry on behalf of such at least one second participant first searchable criteria for proposed matching of such at least one proposed joint event; and computer processing means for retrieving from such computer database means such proposed-event information matching such first searchable criteria. Moreover, it provides such an Internet computer system wherein such at least one type of proposed joint event comprises at least one sporting event.

Additionally, it provides such an Internet computer system wherein at least one of such at least one first participant and such at least one second participant comprises at least one team. Also, it provides such an Internet computer system wherein at least one of such at least one first participant and such at least one second participant comprises at least one couple. In addition, it provides such a Internet computer system further comprising: computer interface means for permitting database entry, on behalf of such at least one first participant, of at least one first skill level of such at least one type of proposed joint event; computer interface means for permitting entry on behalf of such at least one second participant at least one second searchable criterion for proposed matching with such at least one skill level of such at least one type of proposed joint event; computer processing means for retrieving from such computer database means such proposed-event information matching such second searchable criterion. And, it provides such a Internet computer system further comprising computer processing means for retrieving on behalf of such at least one first participant such proposed-event information from such computer database means.

Further, it provides such a Internet computer system further comprising: computer database means for searchably storing participant personal profile information wherein such participant personal profile information comprises at least at least one unique identifier, such at least one type of such proposed joint event, such of at least one first skill level of such at least one type of proposed joint event, demographic information, contact information, computer interface means for database entry on behalf of such at least one first participant such personal profile information; computer interface means for permitting entry on behalf of such at least one second participant at least one third searchable criteria for proposed matching of such personal profile information; and computer processing means for retrieving from such computer database means such first personal profile information matching such third searchable criteria. Even further, it provides such an Internet computer system wherein such personal profile information further comprises at least two of the following: children information, participant background information, personality traits information; favorite foods information; preferred music information; and at least one image.

Moreover, it provides such an Internet computer system further comprising: computer database means for searchably storing at least one bulletin board posting; computer interface means for entry on behalf of such at least one first participant of such at least one bulletin board posting; computer processing means for associating such at least one such bulletin board posting with such at least one first participant; computer interface means for permitting entry on behalf of such at least one second participant at least one fourth searchable criteria for proposed matching with such personal profile information; computer processing means for retrieving such at least one bulletin board posting associated with such personal profile information matching such fourth search criteria. Internet computer system wherein such fourth search criteria comprise: at least one type of proposed joint event, at least one proposed geographic area for such proposed joint event, and at least one proposed time criterion for such at least one proposed joint event. Additionally, it provides such a Internet computer system further comprising computer processing means for assisting such at least one second participant to communicate with such at least one first participant. Also, it provides such a Internet computer system wherein such computer processing means for assisting such at least one second participant to communicate with such at least one first participant comprises: computer processing means for assisting non-disclosure of first contact information of such first participant to such second participant; and computer processing means for assisting non-disclosure of second contact information of such second participant to such first participant.

In accordance with another preferred embodiment hereof, this invention provides a computer system for an Internet computer system, relating to finding at least one proposed joint event for assisting displaying participant personal profile information of at least one first participant by at least one second participant with, comprising: at least one computer process structured and arranged to assist searchably storing proposed-event information wherein such proposed-event information comprises at least at least one type of proposed joint event, at least one proposed geographic area for such proposed joint event, and at least one proposed time criterion for such at least one proposed joint event; at least one computer process structured and arranged to assist permitting input on behalf of such at least one first participant of such at least one proposed joint event; at least one computer process structured and arranged to assist searchably storing such participant personal profile information wherein such participant personal profile information comprises at least at least one unique identifier, such at least one type of such proposed joint event, such of at least one first skill level of such at least one type of proposed joint event, demographic information, and contact information; at least one computer process structured and arranged to assist permitting input on behalf of such at least one first participant such participant personal profile information; at least one computer process structured and arranged to assist permitting associating such entered proposed joint event with such entered participant personal profile information; at least one computer process structured and arranged to assist permitting input on behalf of such at least one second participant first searchable criteria for proposed matching of such at least one proposed joint event; at least one computer process structured and arranged to assist retrieving from such computer database such stored proposed-event information matching such first searchable criteria; and at least one computer process structured and arranged to assist displaying such entered participant profile information associated with such retrieved proposed-event information.

Even further, it provides such a computer system wherein such at least one type of proposed joint event comprises at least one sporting event. Even further, it provides such a computer system wherein at least one of such at least one first participant and such at least one second participant comprises at least one team. Even further, it provides such a computer system wherein at least one of such at least one first participant and such at least one second participant comprises at least one couple. Even further, it provides such a computer system further comprising: at least one computer process structured and arranged to assist permitting input, on behalf of such at least one first participant, of at least one first skill level of such at least one type of proposed joint event; at least one computer process structured and arranged to assist permitting input on behalf of such at least one second participant at least one second searchable criterion for proposed matching with such at least one skill level of such at least one type of proposed joint event; at least one computer process structured and arranged to assist retrieving from such computer database such proposed-event information matching such second searchable criterion; and at least one computer process structured and arranged to assist displaying such entered participant profile information associated with such retrieved proposed-event information. Even further, it provides such a computer system further comprising at least one computer process structured and arranged to assist retrieving on behalf of such at least one first participant such proposed-event information from such computer database.

Even further, it provides such a computer system further comprising: at least one computer process structured and arranged to assist permitting input on behalf of such at least one second participant at least one third searchable criteria for proposed matching of such personal profile information; and at least one computer process structured and arranged to assist retrieving from such computer database such personal profile information matching such third searchable criteria. Even further, it provides such a computer system wherein such personal profile information further comprises at least two of the following: children information, participant background information, personality traits information; favorite foods information; preferred music information; and at least one image. Even further, it provides such a computer system further comprising: at least one computer process structured and arranged to assist searchably storing at least one bulletin board posting; at least one computer process structured and arranged to assist permitting entry on behalf of such at least one first participant of such at least one bulletin board posting; at least one computer process structured and arranged to assist associating such at least one such bulletin board posting with such at least one first participant; at least one computer process structured and arranged to assist permitting input on behalf of such at least one second participant at least one fourth searchable criteria for proposed matching with such personal profile information; at least one computer process structured and arranged to assist retrieving such at least one bulletin board posting associated with such personal profile information matching such fourth search criteria.

Even further, it provides such a computer system wherein such fourth search criteria comprises: at least one type of proposed joint event, at least one proposed geographic area for such proposed joint event; and at least one proposed time criterion for such at least one proposed joint event. Even further, it provides such a computer system further comprising at least one computer process structured and arranged to assist assisting such at least one second participant to communicate with such at least one first participant. Even further, it provides such a computer system wherein such at least one computer process structured and arranged to assist assisting such at least one second participant to communicate with such at least one first participant comprises: at least one computer process structured and arranged to assist assisting non-disclosure of first contact information of such first participant to such second participant; and at least one computer process structured and arranged to assist assisting non-disclosure of second contact information of such second participant to such first participant.

### DEFINITIONS, ACRONYMS AND CROSS-REFERENCES

The following terms and acronyms are explained below as background and are used throughout the detailed description:

BLOG (Web log or Weblog). Any system that supports an online diary such as a personal chronological log of thoughts published on a Web page or a shared on-line journal where people can post diary entries about their personal experiences and hobbies.

Chat/Chat Room. Any system that allows any number of users to have a typed (and/or voice-based), real-time, on-line conversation, either by all users logging into the same computer, or more commonly nowadays, via a network. Using special software, Internet users can enter chat areas or “virtual spaces,” where they can communicate in real time.

Client-Server. A model of interaction in a distributed system in which a program at one site sends a request to a program at another site and waits for a response. The requesting program is called the “client,” and the program that responds to the request is called the “server.” In the context of the World Wide Web, the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name System (DNS). An Internet service that translates domain names (which are alphabetic identifiers) into IP addresses (which are numeric identifiers for machines on a TCP/IP network).

Email. A system for sending and receiving messages electronically over a computer network, as between personal computers.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other Web sites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Inline FRAME. A floating frame, with content just like an ordinary frame, included in the HTML 4 standard. Inline Frames are useful for maintaining a frame of information on the user's display at all time even when the underlying content is scrolled up or down.

Instant Messaging. Abbreviated IM, a type of communications service that enables you to create a kind of private chat room with another individual in order to communicate in real time over the Internet, analogous to a telephone conversation but using text-based, not voice-based, communication. Typically, the instant messaging system alerts you whenever somebody on your private list is online. You can then initiate a chat session with that particular individual.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers and client information, in an inter-office setting.

PHP. A server-side, cross-platform, HTML-embedded scripting language used to create dynamic Web pages. PHP is Open Source software.

Short Message Service (SMS). A service available on most digital mobile phones (and other mobile devices, e.g. a Pocket PC, or occasionally even desktop computers) that permits the sending of short messages (also known as text messages, or more colloquially SMSes, texts or even txts) between mobile phones, other handheld devices and even landline telephones. Messages are sent via a store-and-forward mechanism to a Short Message Service Centre (SMSC), which will attempt to send the message to the recipient. If the user is not reachable at a given moment, the SMSC will save the message. Later when the user is reachable, the SMSC will retry the delivery process.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

The Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Corner and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### BRIEF DESCRIPTION OF THE DRAWINGS

FIG. 1 shows a diagrammatical overview of the Internet communications used in the instant system according to a preferred embodiment of the present invention.

FIG. 2 shows a simplified functional diagrammatical overview of the relationship among the Web site server and users of the instant system according to a preferred embodiment of the present invention.

FIG. 3 shows a simplified functional diagrammatical overview of the relationship between the Web server and the Matchmaker Web site and its primary functions, according to the preferred embodiment of FIG. 1.

FIG. 4 shows a summary schematic of the primary entities and their relationships associated with the instant system and method, according to the preferred embodiment of the present invention.

FIG. 5 shows a summary schematic of the primary steps which may be completed in the instant system and method, according to the preferred embodiment of the present invention.

FIG. 6 shows an example of a screen for the Web site home page screen presented to visitors according to a preferred embodiment of the present invention.

FIG. 7 shows an example of a welcome screen displayed after member login according to a preferred embodiment of the present invention.

FIG. 8 shows an example of a member registration screen used to register new members according to a preferred embodiment of the present invention.

FIG. 9 shows an example of a singles member profile screen that is completed by new single members according to a preferred embodiment of the present invention.

FIG. 10 shows an example of a screen used by members to add a photo their member profile according to a preferred embodiment of the present invention.

FIG. 11 shows an example of a couple's member profile screen that is completed by new members joining as a couple according to a preferred embodiment of the present invention.

FIG. 12 shows an example of a team's member profile screen that is completed by new members joining as a team according to a preferred embodiment of the present invention.

FIG. 13 shows an example of a Match Request screen used by members to input desired match information for a particular activity, usually a sport-related activity, according to a preferred embodiment of the present invention.

FIG. 14 shows an example of a screen reminding a member that a new sports skill will be added to their profile when requesting a match according to a preferred embodiment of the present invention.

FIG. 15 shows an example of a quick search screen used to find a member by their screen name according to a preferred embodiment of the present invention.

FIG. 16 shows an example of a member search screen which permits a member to search for members with specific attributes according to a preferred embodiment of the present invention.

FIG. 17 shows an example of kids search screen which permits a member to search for kids with a specific set of attributes according to a preferred embodiment of the present invention.

FIG. 18 shows an example of a member search results screen according to a preferred embodiment of the present invention.

FIG. 19 shows an example of a completed member profile according to a preferred embodiment of the present invention.

FIG. 20 shows an example of a member's favorites list screen according to a preferred embodiment of the present invention.

FIG. 21 shows an example of a member's photo screen according to a preferred embodiment of the present invention.

FIG. 22 shows an example of an email screen permitting members to email each other according to a preferred embodiment of the present invention.

FIG. 23 shows an example of an instant messaging screen permitting members to message each other according to a preferred embodiment of the present invention.

FIG. 24 shows an example of a Match Search screen for searching for members that have entered desired match information according to a preferred embodiment of the present invention.

FIG. 25 shows an example of a Search Results screen displaying all members' profile information for members having input match information matching search criteria entered by a member according to a preferred embodiment of the present invention.

FIG. 26 shows an example of a bulletin board search screen permitting a member to search for possible match requests posted to the bulletin board according to a preferred embodiment of the present invention.

FIG. 27 shows an example of a bulletin board posting matching a member's search according to a preferred embodiment of the present invention.

FIG. 28 shows an example of a bulletin board post screen which permits a member to add a new bulletin board posting according to a preferred embodiment of the present invention.

FIG. 29 shows an example of a directory search screen which permits members to search for Advertisers according to a preferred embodiment of the present invention.

FIG. 30 shows an example of location listing screen for a member's search criteria according to a preferred embodiment of the present invention.

FIG. 31 shows an example of a map request screen for obtaining a map or directions to a selected advertiser's location according to a preferred embodiment of the present invention.

FIG. 32 shows an example of an advertiser information screen used by prospective Advertisers according to a preferred embodiment of the present invention.

FIG. 33 shows an example of the first sign up screen used by an advertiser to place the information on the Web site according to a preferred embodiment of the present invention.

FIG. 34 shows an example of advertiser or location provider instructions screen for guiding Advertisers through the set up process according to a preferred embodiment of the present invention.

FIG. 35 shows an example of an advertising help screen which provides answers to Advertisers' frequently asked questions according to a preferred embodiment of the present invention.

FIG. 36 shows an example of a member's shopping opportunities screen displaying retailers offering discounts through the Web site according to a preferred embodiment of the present invention.

FIG. 37 shows an example of a member's shopping opportunities screen displaying Advertisers and retailers, within a particular category, offering discounts through the Web site according to a preferred embodiment of the present invention.

FIG. 38 shows an example of a chat screen used by members to chat when both are online according to a preferred embodiment of the present invention.

FIG. 39 shows an example of an alternate Search Results screen displaying all members' profile information for members having input match information matching search criteria entered by a member according to a preferred embodiment of the present invention.

FIG. 40 shows an example of a member profile that may be sent via text (SMS) messaging screen to another member according to a preferred embodiment of the present invention.

FIG. 41 shows an example of a text (SMS) messaging screen permitting members to text (SMS) message each other according to a preferred embodiment of the present invention.

FIG. 42 shows an example of an administrator's screen permitting approval or disapproval of advertisements submitted by Players Guide Advertisers according to a preferred embodiment of the present invention.

FIG. 43 shows an example of an advertiser edit screen permitting an advertiser to edit previously submitted advertisements according to a preferred embodiment of the present invention.

FIG. 44 shows an example of a user profile illustrating capability of member linking to a Player's Network according to a preferred embodiment of the present invention.

FIG. 45 shows an example of the Player's Network screen of a user according to a preferred embodiment of the present invention.

FIG. 46 shows an example of the Match Request Notification Service of the Player's Network screen according to a preferred embodiment of the present invention.

FIG. 47 shows an example of a Match Request Notification Service on the Matches screen according to a preferred embodiment of the present invention.

FIG. 48 shows an example of a Message Center screen according to a preferred embodiment of the present invention.

FIG. 49 shows an example of a One Click Match Join feature according to a preferred embodiment of the present invention.

FIG. 50 shows an example of a Match screen according to a preferred embodiment of the present invention.

FIG. 51 shows an example of a Match History feature of the My Confirmed Matches heading according to a preferred embodiment of the present invention.

FIG. 52 shows a simplified diagrammatic overview illustrating, in a simplified form, features of the Matchmaker Web site according to the preferred embodiment of the present invention.

FIG. 53 shows another simplified diagrammatic overview illustrating other features of the Matchmaker Web site according to the preferred embodiment of the present invention.

FIG. 54 shows a simplified diagrammatic overview illustrating, generally, methods of communicating among registered users of the Matchmaker Web site according to the preferred embodiment of the present invention.

### DETAILED DESCRIPTION OF THE BEST MODES AND PREFERRED EMBODIMENTS OF THE INVENTION

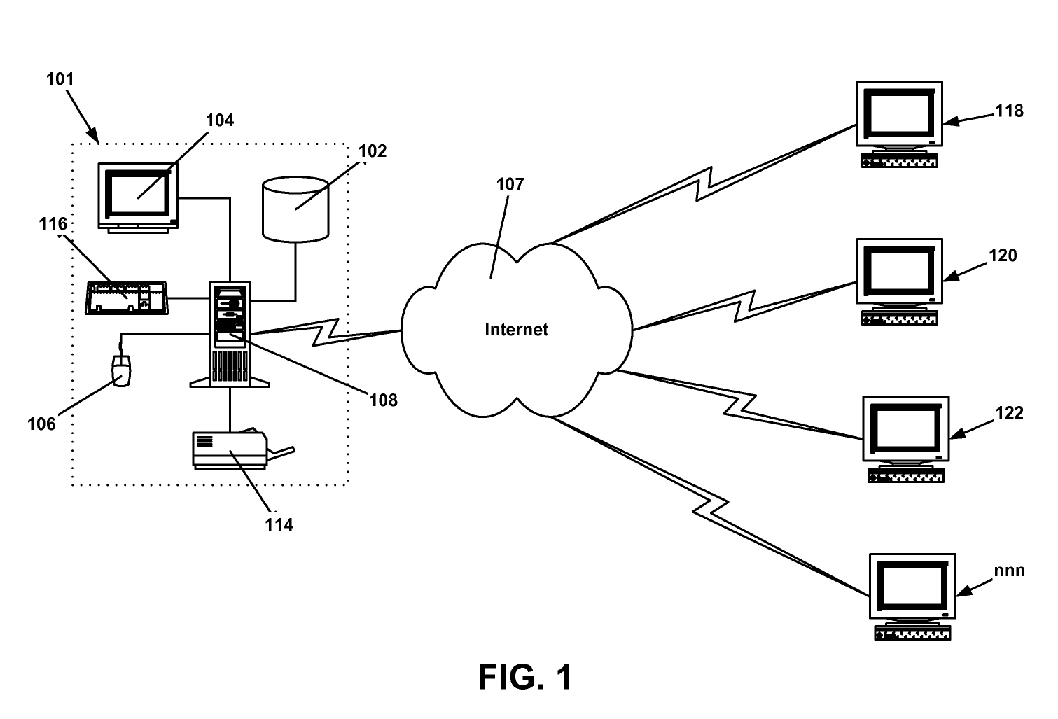

FIG. 1 shows a diagrammatical overview of the Internet communications used in the instant system according to a preferred embodiment of the present invention. Preferably the present invention comprises Web server 101 connected by way of the Internet 107 to users 118, 120, 122 and nnn. Web server 101 preferably comprises computer system 108 which comprises input and output devices. Computer system 108 preferably comprises display screen or monitor 104, keyboard 116, printer 114, and mouse 106. Computer system 108 further preferably comprises database 102 for storage of the data and software comprising preferred embodiments of the present invention. Computer system 108 is preferably connected to the Internet 107 that serves as the presently preferred communications medium using http (hypertext transport protocol) as a preferred protocol. The Internet 107 comprises a global network of networks and computers, both public and private. The Internet 107 is the preferred connection method by users 118, 120, 122 and nnn in preferred embodiments of the present invention.

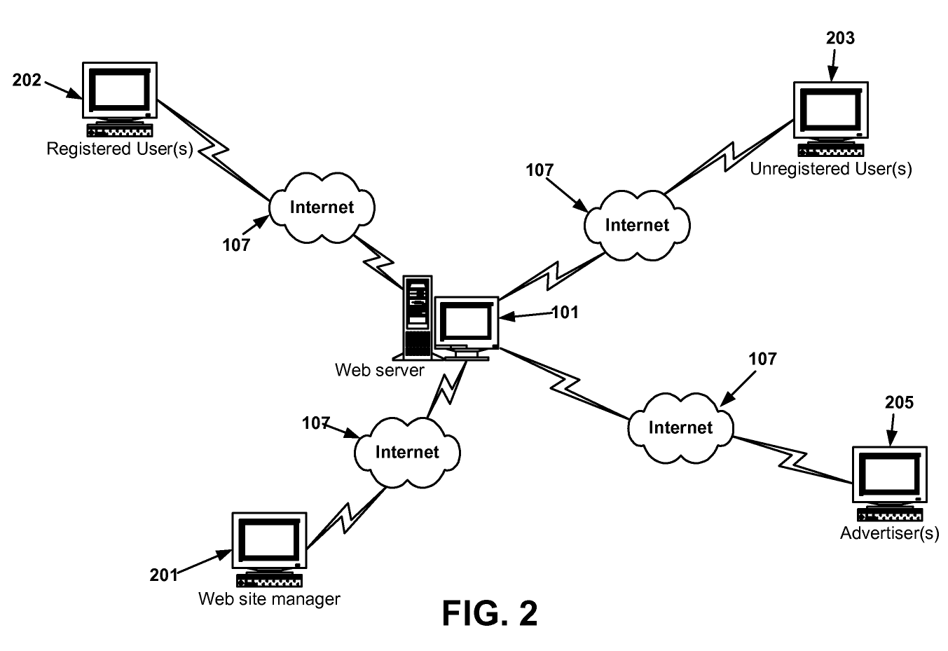

FIG. 2 shows a simplified functional diagrammatical overview of the relationship among the Web site server and users of the instant system according to a preferred embodiment of the present invention. Preferably, at least one Registered User 202 will use a Web browser, such as Internet Explorer, to connect to Web server 101 through the Internet 107. Once connected, Registered User 202 will login and begin using the functions available to them. Similarly, at least one Unregistered User 203 will use a Web browser, such as Internet Explorer, to connect to Web server 101 through the Internet 107. Once connected Unregistered User 203 is preferably encouraged to register and become a member. Preferably, Unregistered User 203 is not required to register; however, Unregistered Users will not be able to utilize all the functions available to Registered Users until they register. Likewise, Advertiser 205 wishing to advertise on Web site 301 preferably uses a Web browser, such as Internet Explorer, to connect to Web server 101 through use of the Internet 107 to set up and maintain their advertisements and advertising campaigns. Finally, Web site manager 201 also preferably uses a Web browser, such as Internet Explorer, to connect to Web server 101 through use of the Internet 107 to operate and maintain Web site 301.

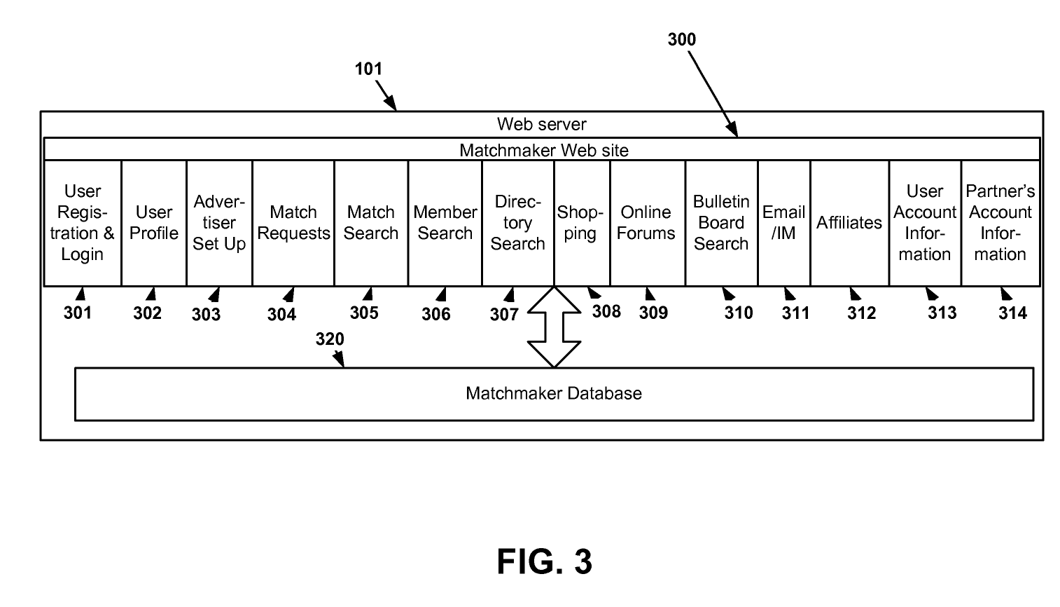

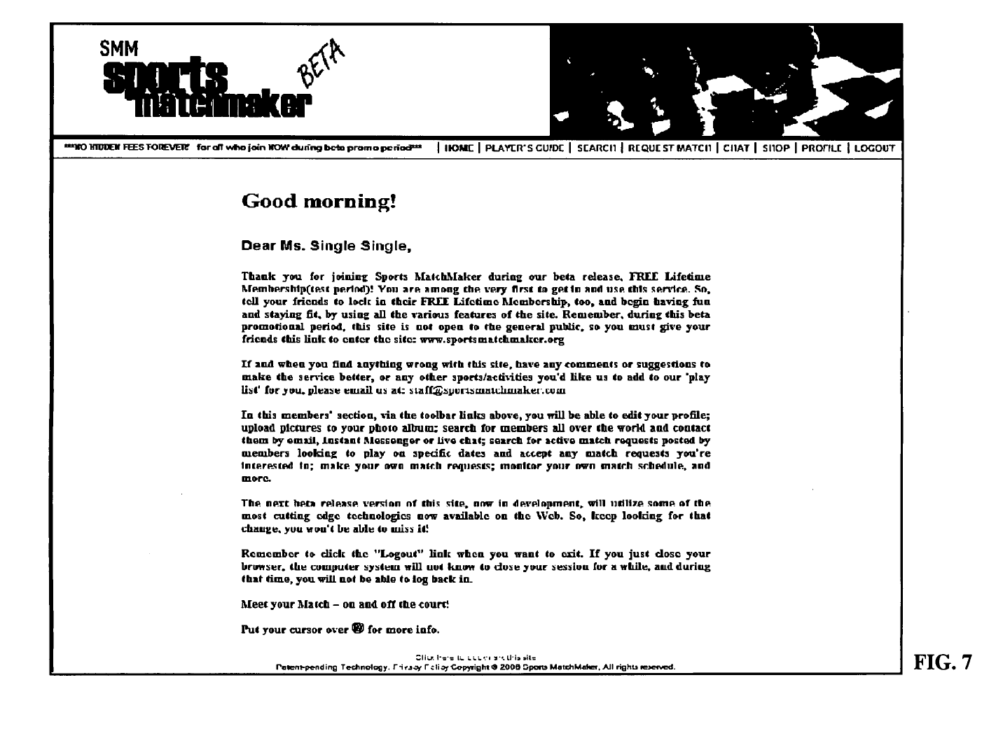

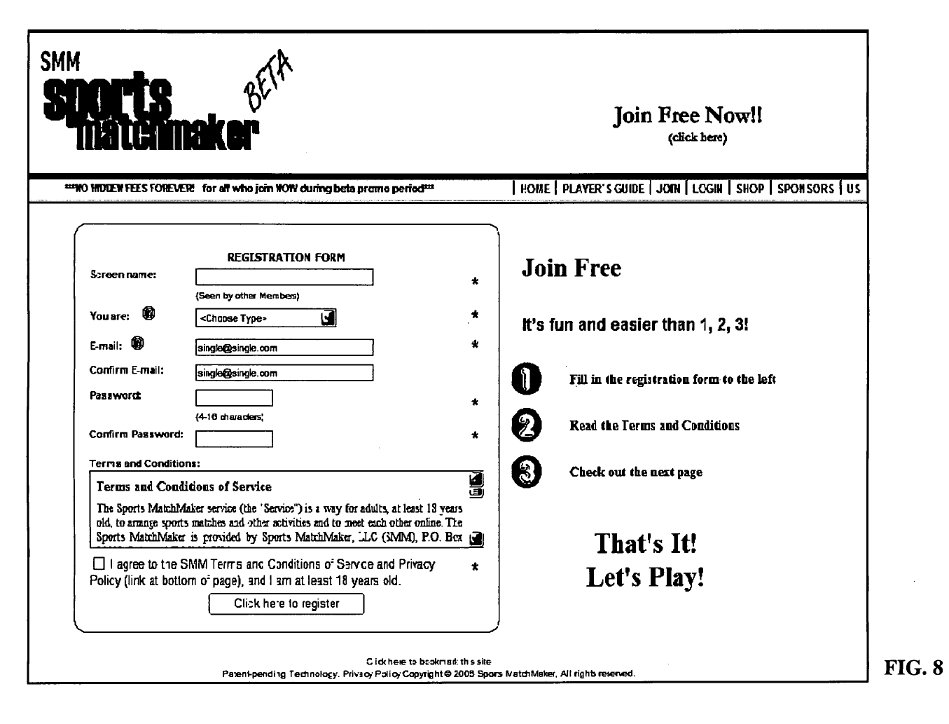

FIG. 3 shows a simplified functional diagrammatical overview of the relationship between Web server 101 and the Matchmaker Web site 300 and its primary functions, according to the preferred embodiment of FIG. 1. Substantially all functional components and Matchmaker Database 320 of Web site 300 preferably reside on Web server 101. The functional component User Registration & Login 301 preferably comprises login functions for Registered Users, and registration processes for Unregistered Users (see FIGS. 6-8). Such functional components preferably comprise User Registration & Login 301, User Profile 302, Advertiser Set Up 303, Match Requests 304, Match Search 305, Member Search 306, Directory Search 307, Shopping 308, Online Forums 309, Bulletin Board Search 310, Email/IM 311, Affiliates 312, User Account Information 313, and Partner's Account Information 314, as shown.

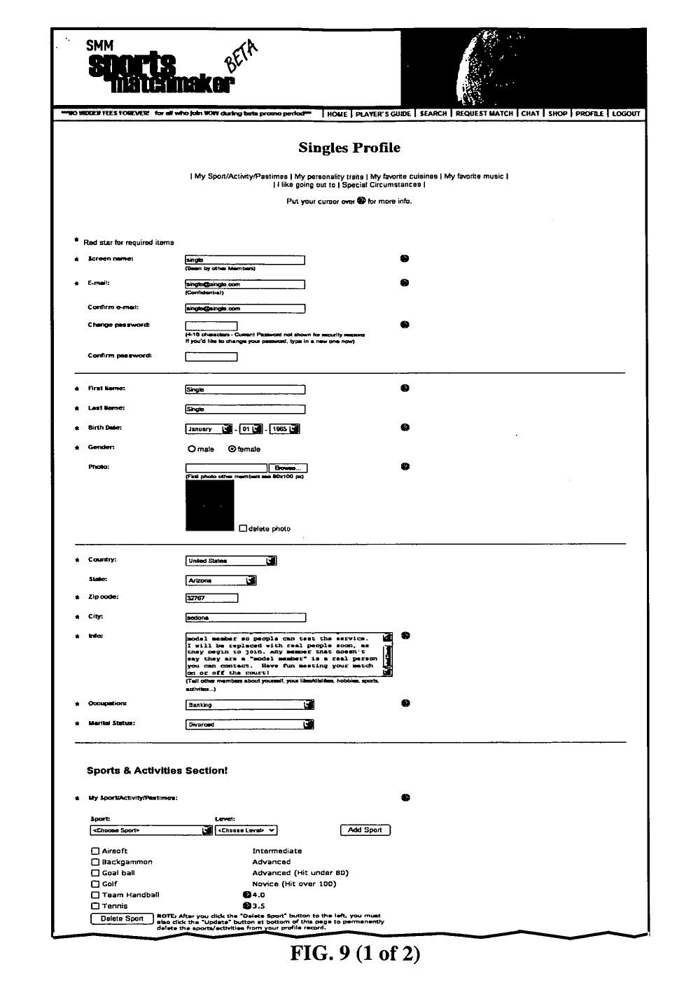

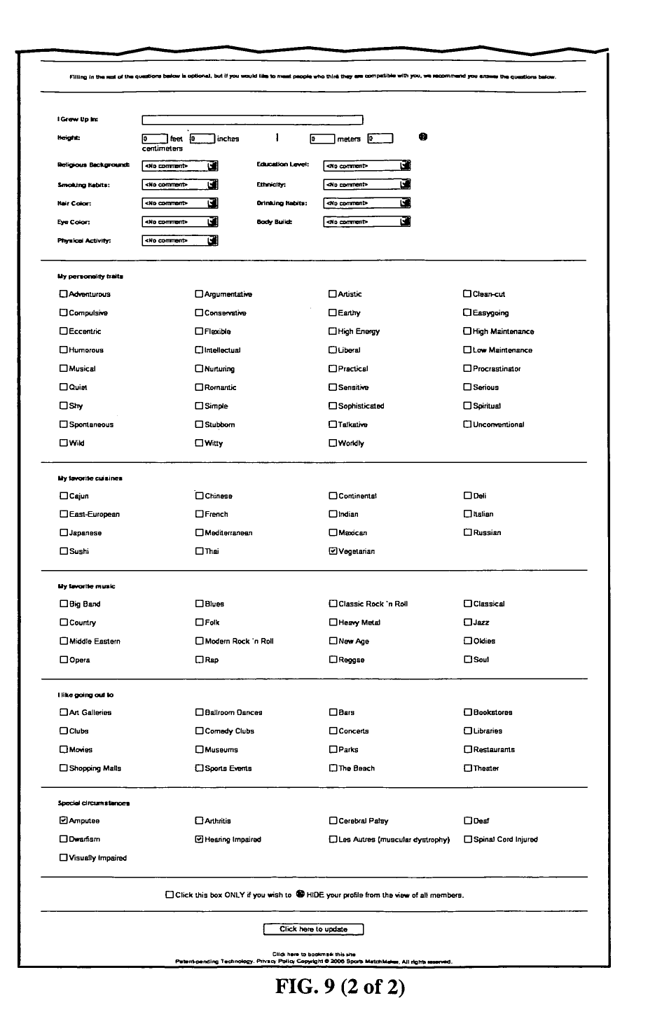

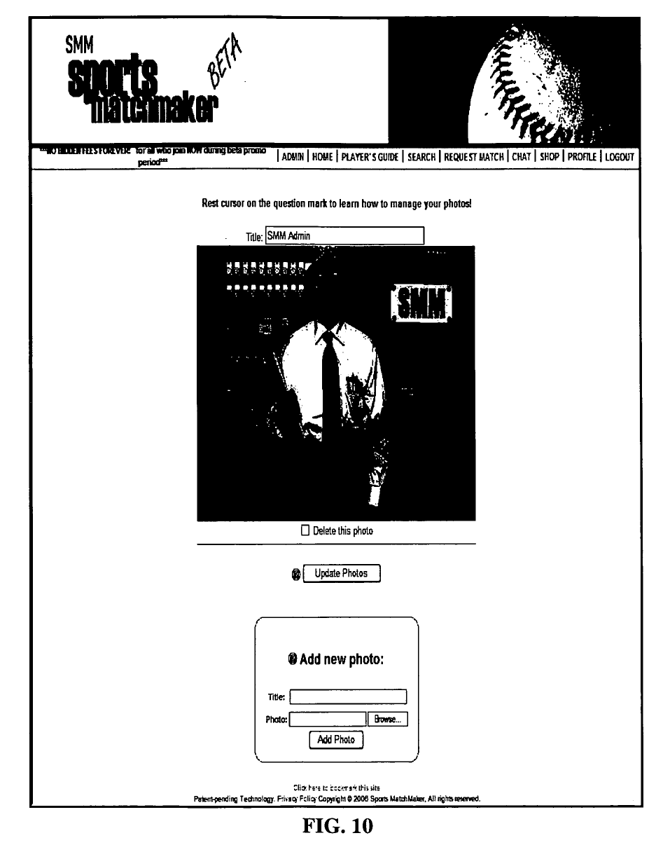

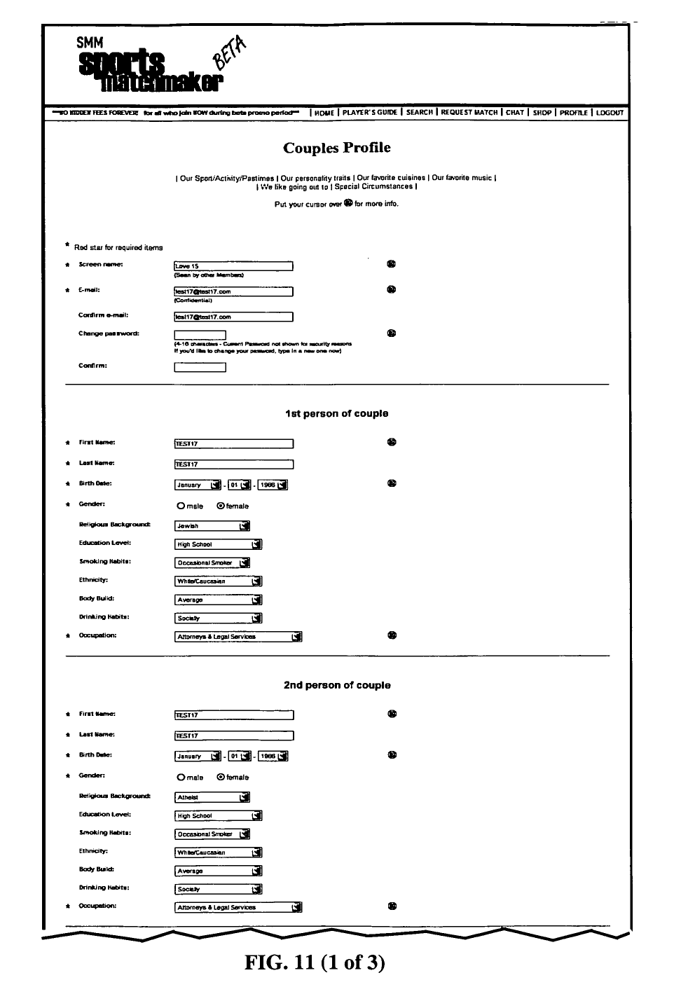

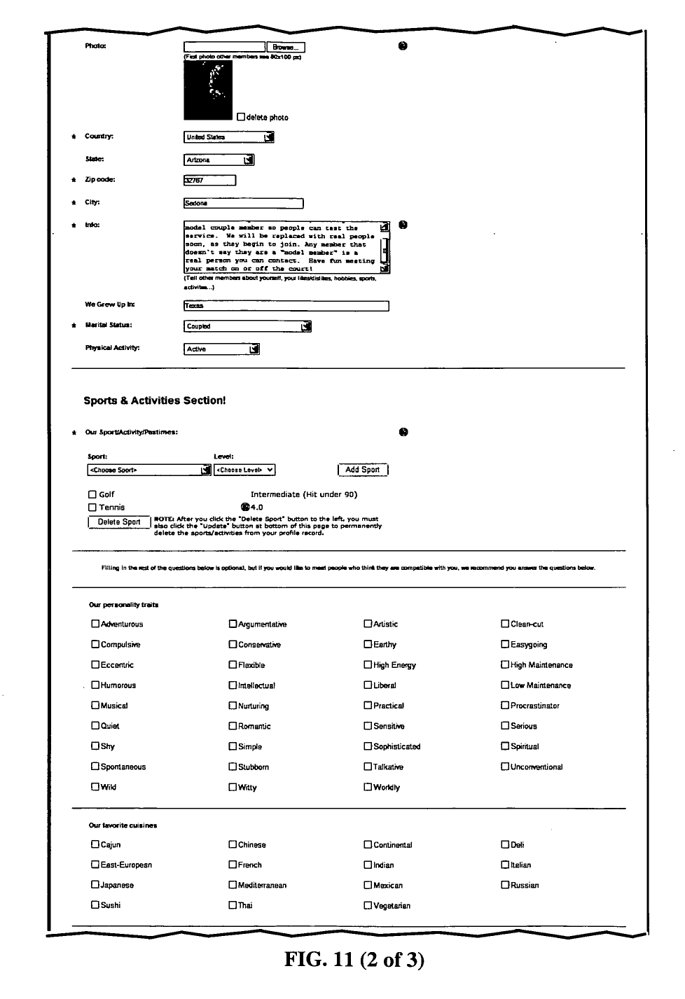

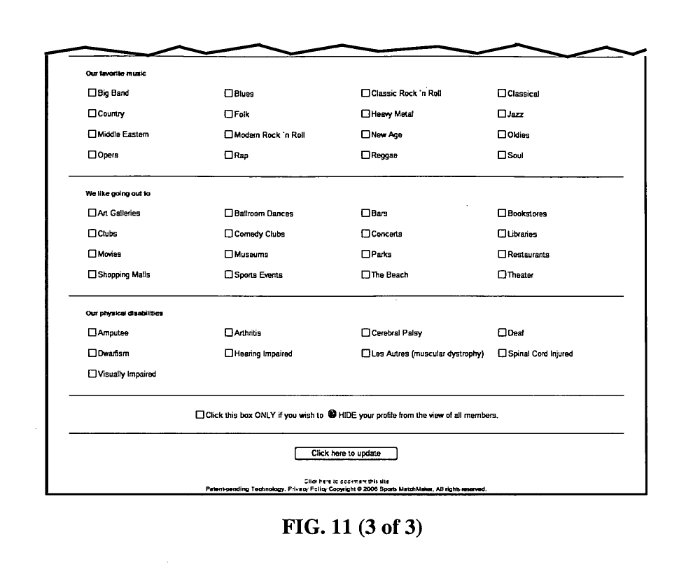

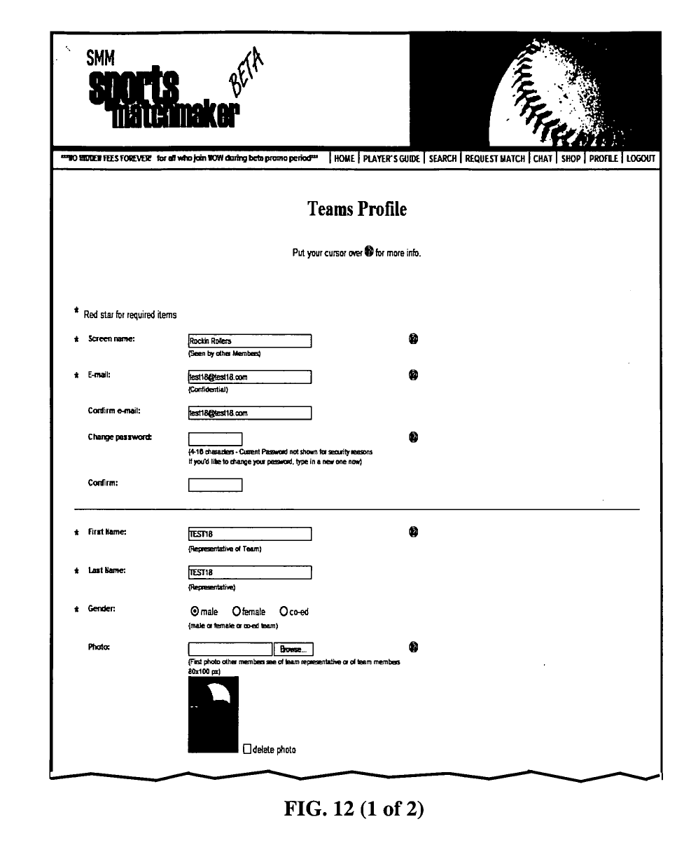

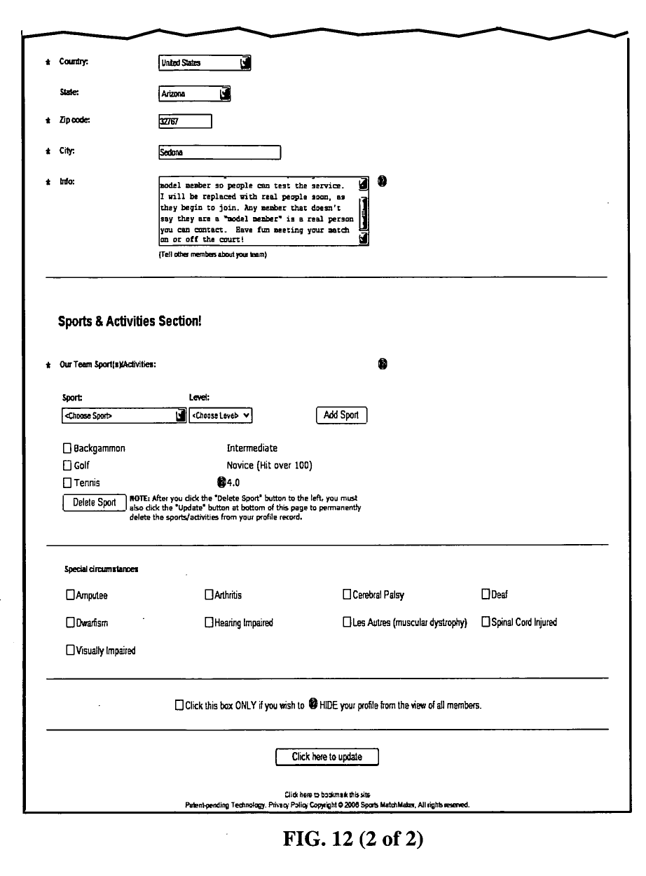

Functional component User Profile 302 permits Registered Users to create or update their profile information. Preferably, Unregistered Users may register and then complete the profile information as an individual, a couple, a team, or a parent who may complete a profile on behalf of his or her children (See FIG. 9, FIG. 10, FIG. 11, and FIG. 12) (at least herein embodying wherein at least one of such at least one first participant and such at least one second participant comprises at least one team; and at least herein embodying wherein at least one of such at least one first participant and such at least one second participant comprises at least one couple). Preferably, Registered Users also use User Profile 302 to update their profile information. Upon reading the teachings of this specification, those with ordinary skill in the art will now understand that, under appropriate circumstances, considering such issues as user preference, competitive requirements, etc., a searchable value such as an entity, which may be an employer, a company, a sports club, a hotel, a fitness center, other organizations, etc., may be input, stored, and associated with a Registered User.

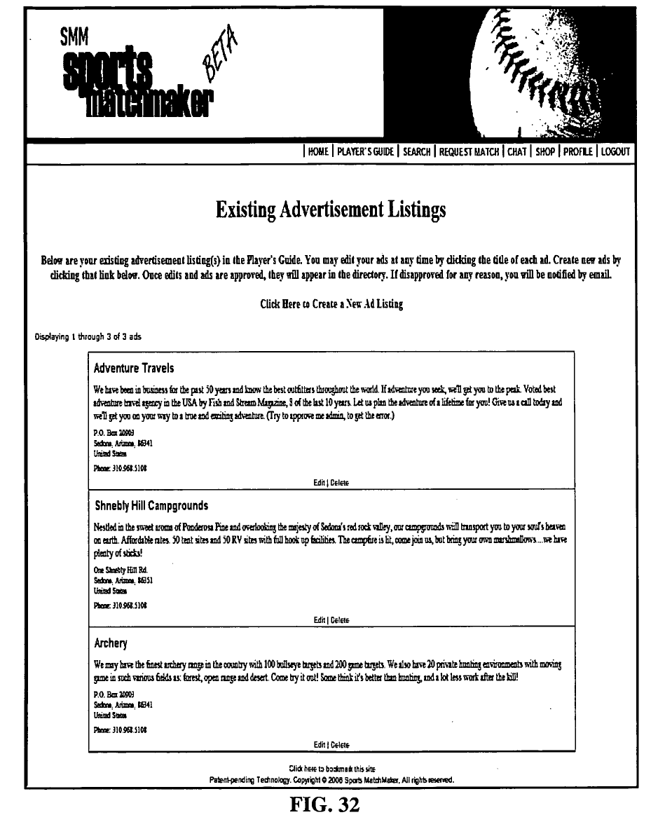

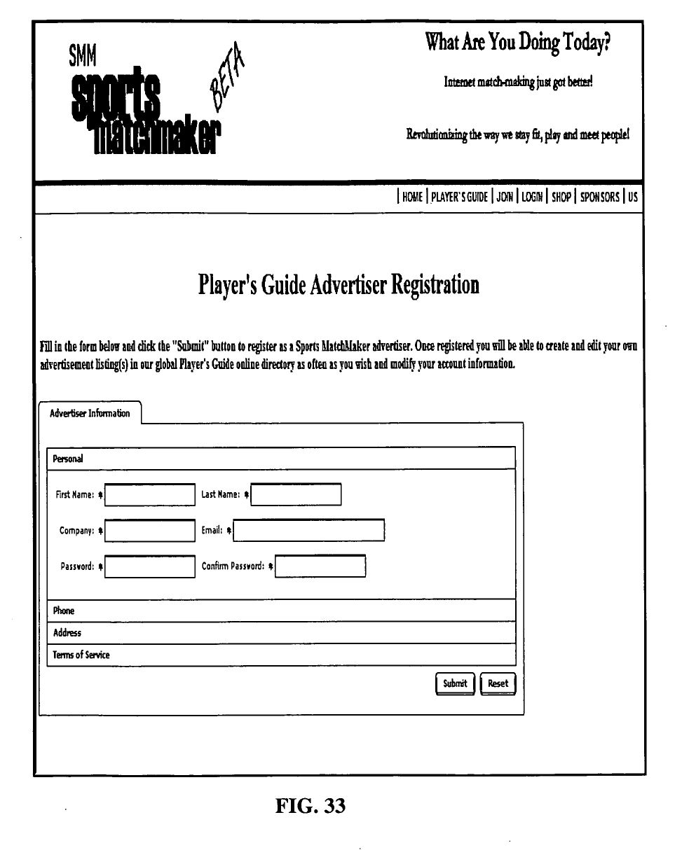

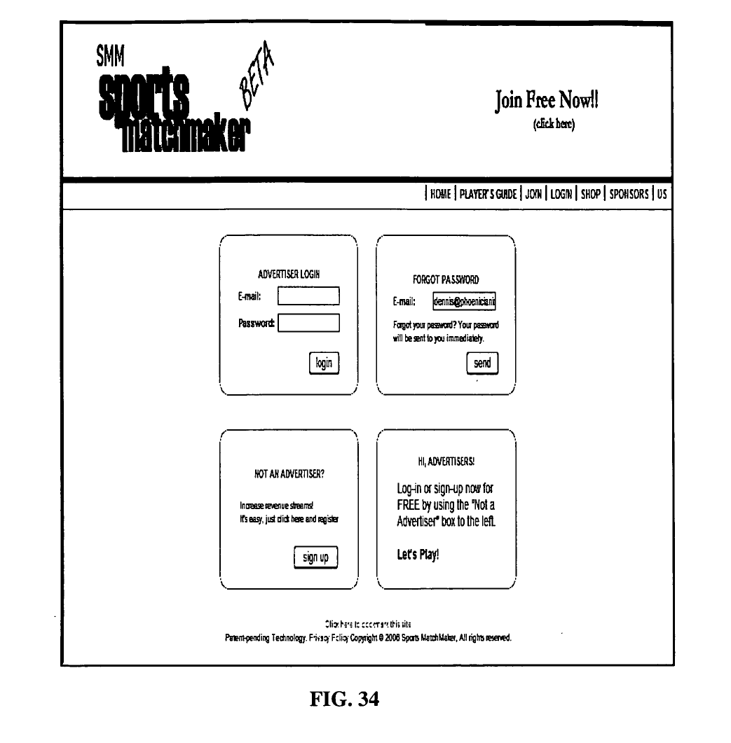

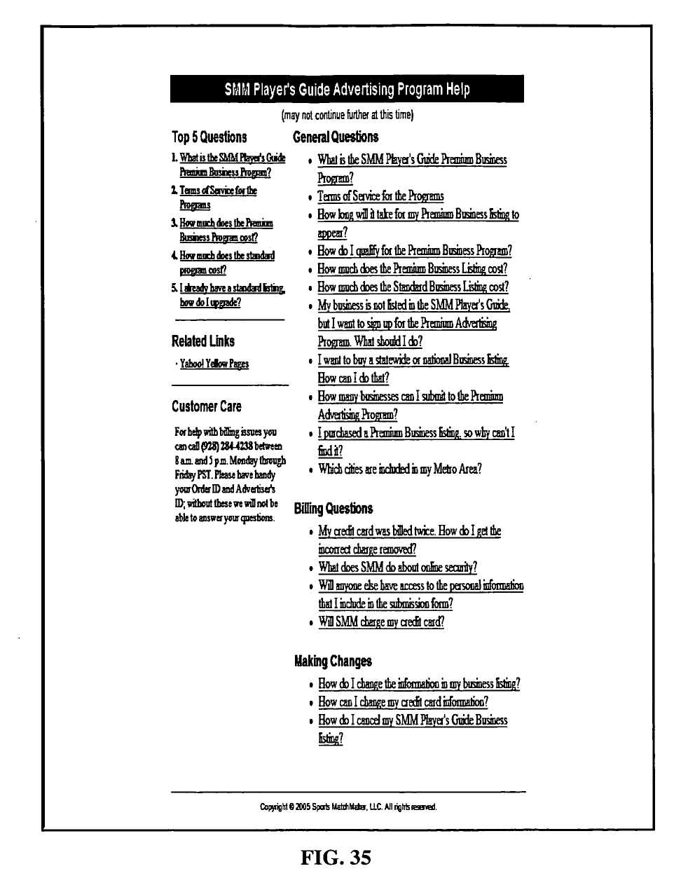

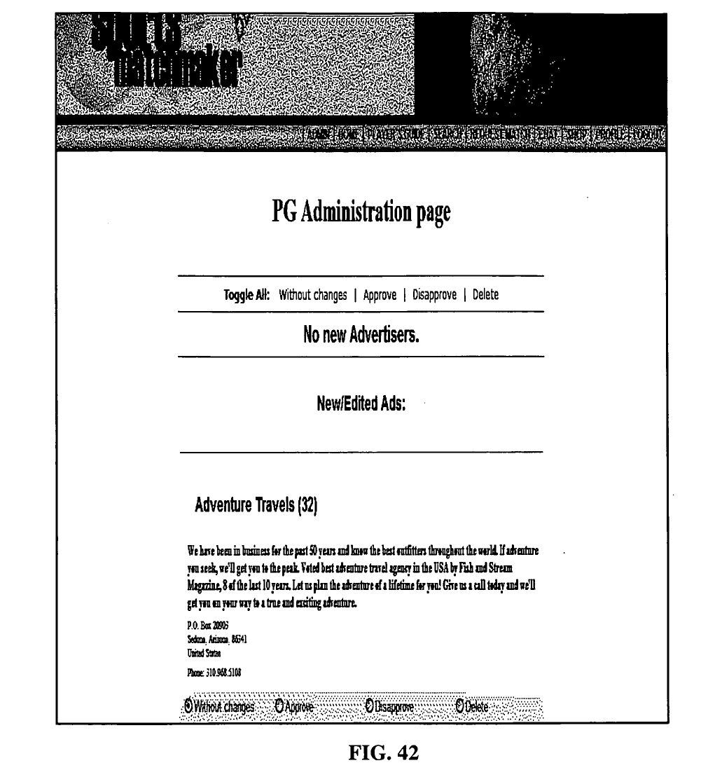

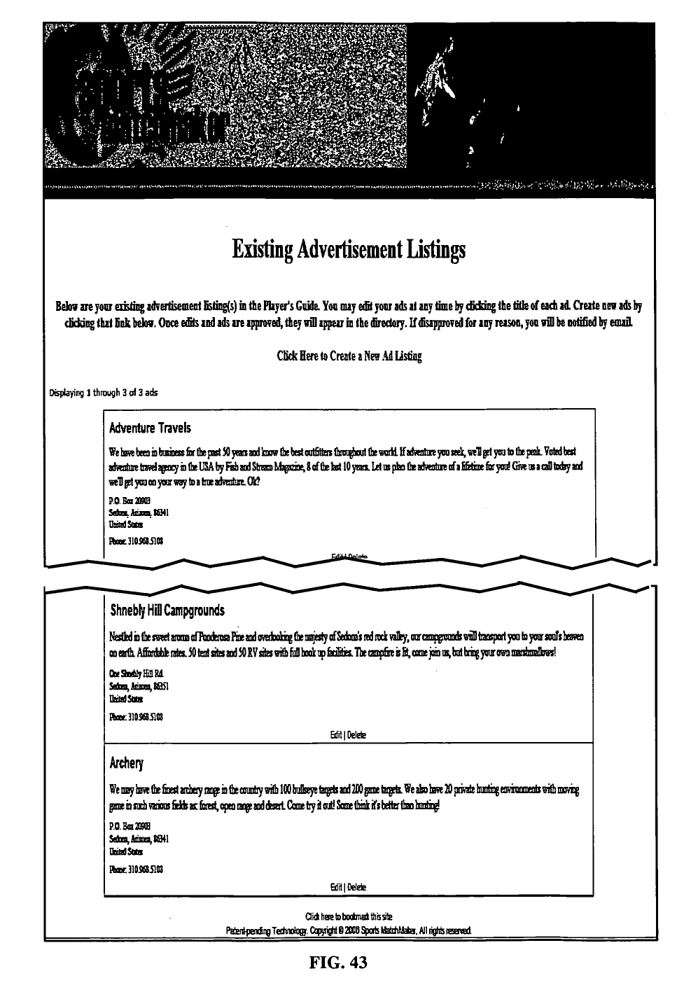

Advertiser Set Up 303 is preferably used to establish new Advertiser accounts, update existing Advertiser accounts, and create and modify advertising information to be displayed on Matchmaker Web site 300 as part of a directory of venues (Player's Guide). Preferably, Advertiser Set Up 303 also provides help instructions, frequently asked question lists, and advertising plan costs and benefit explanations, including preferred placement within the directory of business entities. Preferably, Advertiser 205 provides specific information about their business, its location and any special offers (See FIG. 32, FIG. 33, FIG. 34, and FIG. 35). Preferably, Advertiser 205 may create Advertiser's own directory listing and then checkout by making the required payment using a credit card or other form of Internet-based payment, such as Pay-Pal. Preferably, after payment is made, the submitted advertisement is reviewed by Web site administrator (See FIG. 42) for approval. Preferably, if the advertisement is approved, Web site administrator will permit the advertisement to be posted in the directory requested by Advertiser 205. Preferably, Advertiser 205 may review approved directory listings (advertisements) and make changes or remove any or all directory listings (See FIG. 43) (at least herein embodying after such step of receiving payment, approving such at least one Web site advertisement; and at least herein embodying displaying such approved such at least one Web site advertisement).

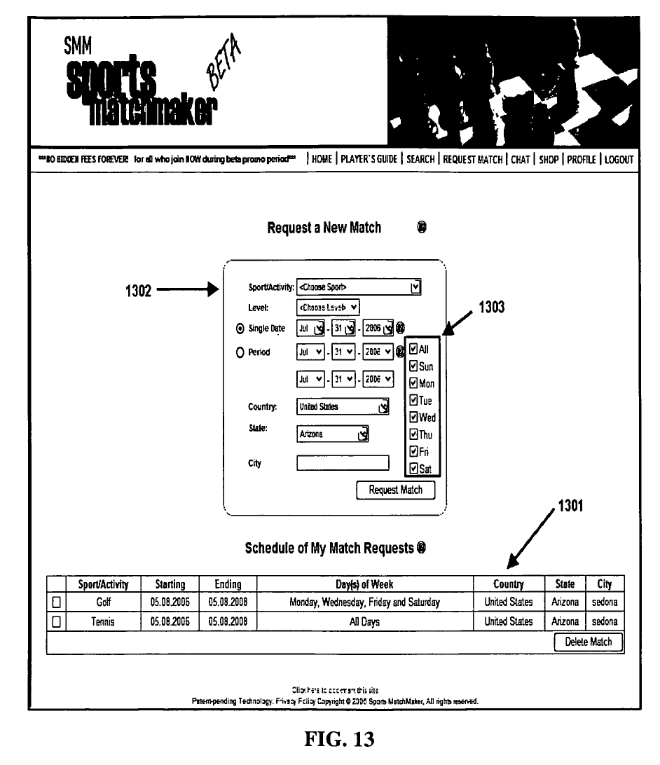

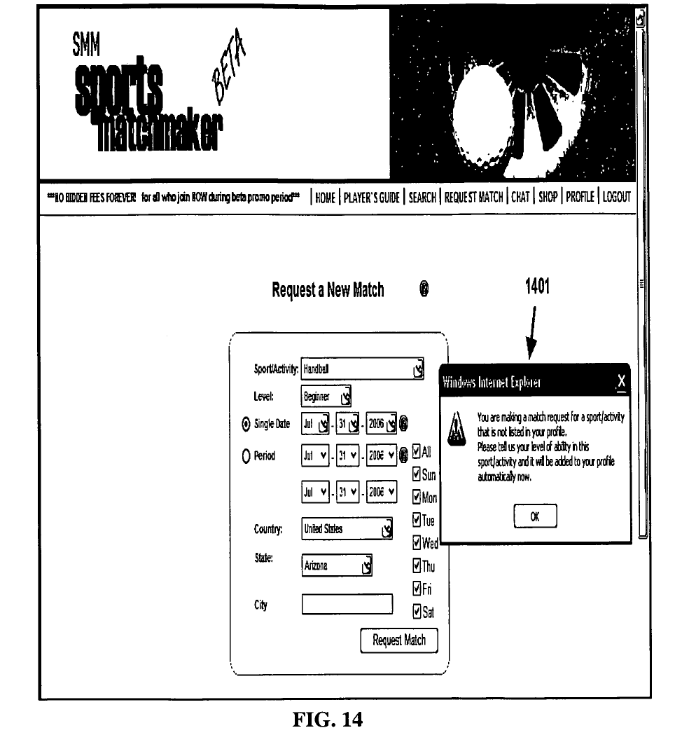

Match Request 304 is preferably used by a Registered Users to create and store an offer to meet another Registered User at a specific place and time for a sporting or social event (at least herein embodying computer database means for searchably storing proposed-event information wherein such proposed-event information comprises at least at least one type of proposed joint event, at least one proposed geographic area for such proposed joint event, and at least one proposed time frame for such at least one proposed joint event; at least herein embodying computer interface means for permitting database entry on behalf of such at least one first participant of such at least one proposed joint event; and at least herein embodying wherein such at least one type of proposed joint event comprises at least one sporting event). As shown in FIG. 13, preferably previous match requests made by Registered User 202 are listed in Schedule of My Match Requests 1301 (shown below Request Match Dialog 1302). Preferably, when a Registered User completes Request Match Dialog 1302 for a sport/activity not in their profile, Add Sport/Activity Reminder 1401 is presented as demonstrated in FIG. 14 (at least herein embodying computer processing means for retrieving on behalf of such at least one first participant such proposed-event information from said computer database means). Preferably, Registered User 202 may remove, or delete, any match request shown in Schedule of My Match Requests 1301.

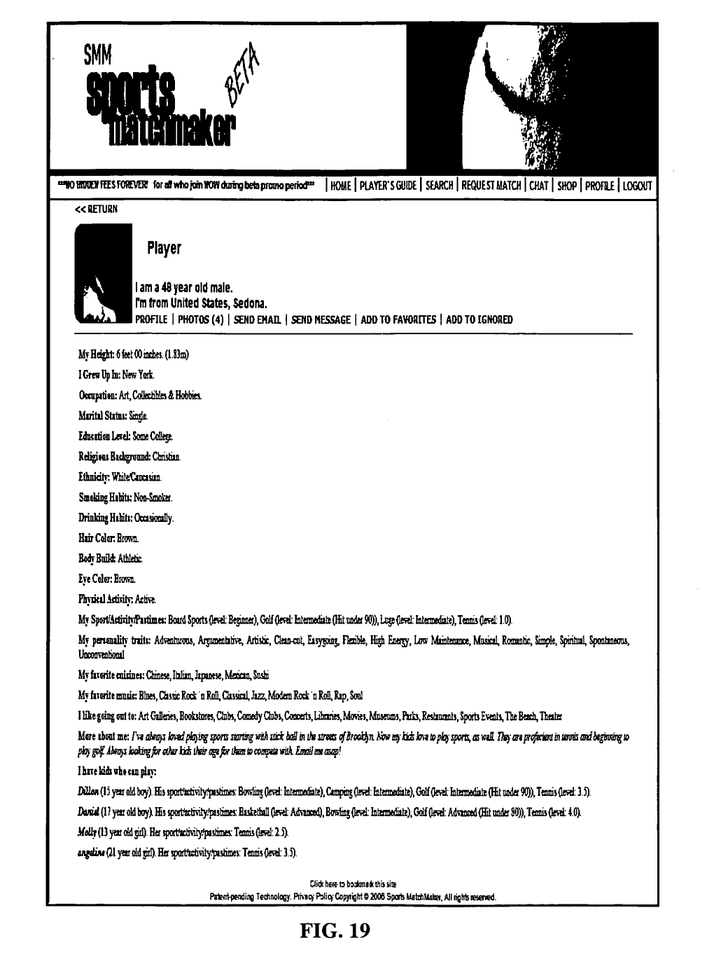

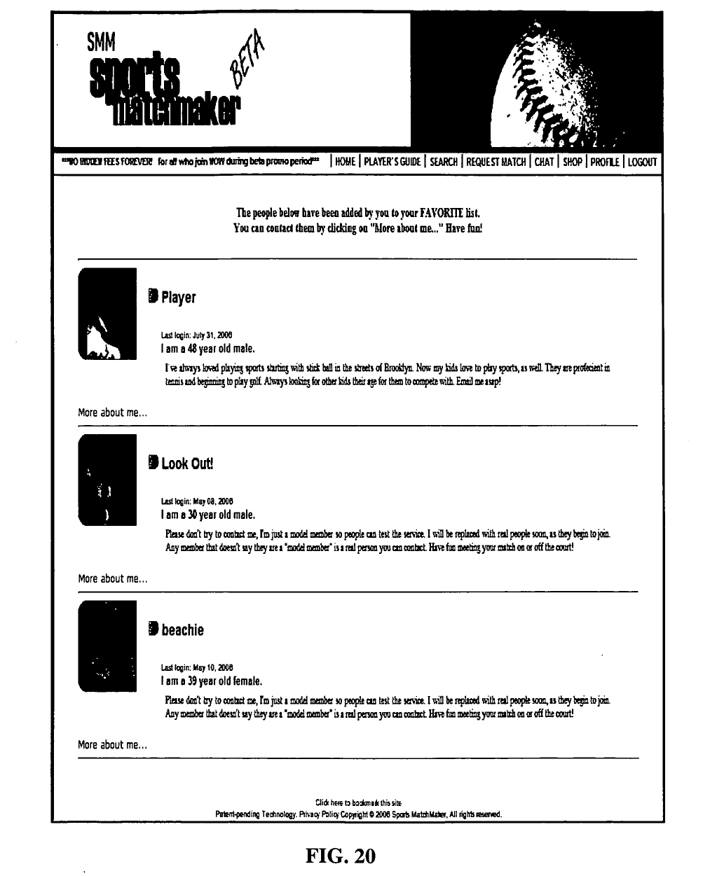

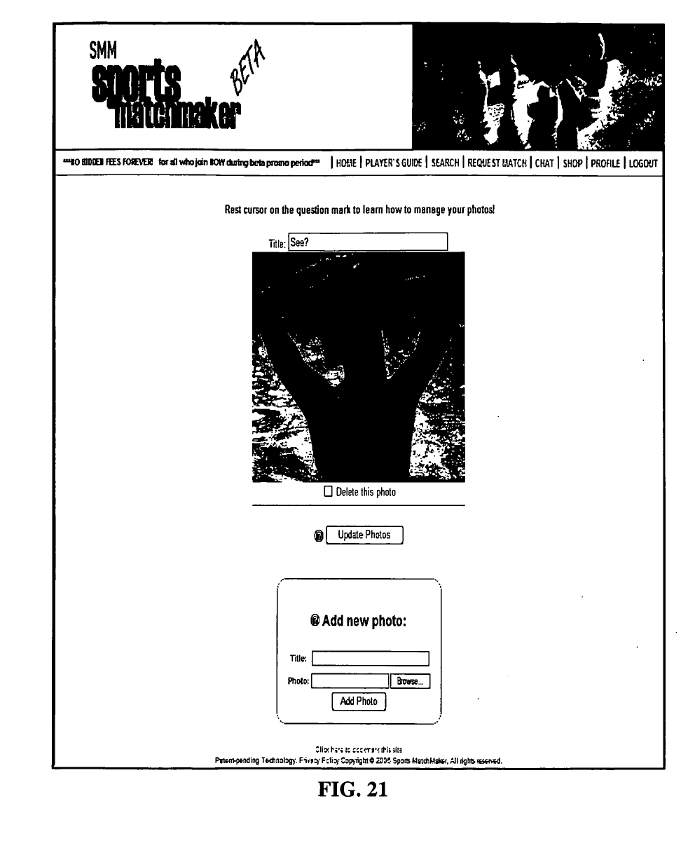

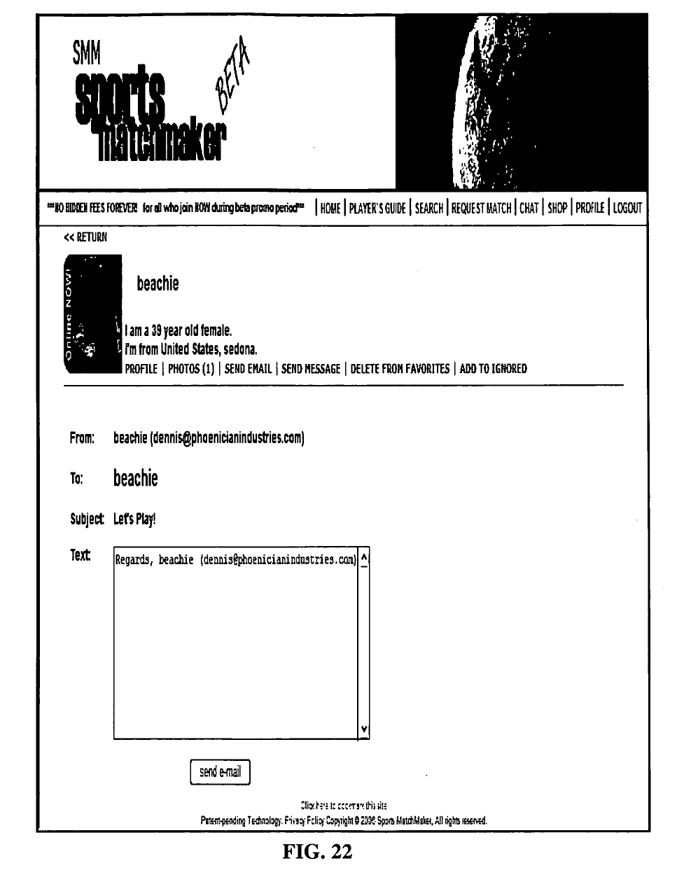

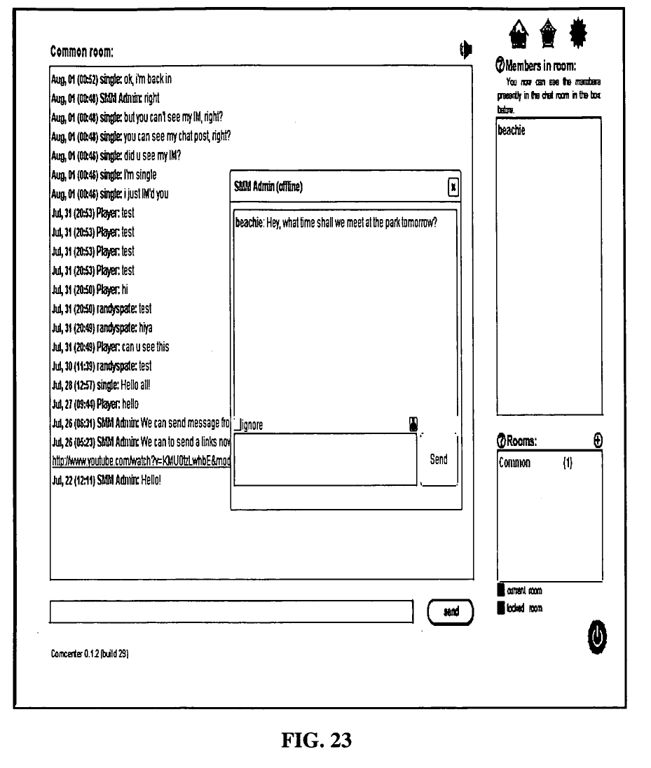

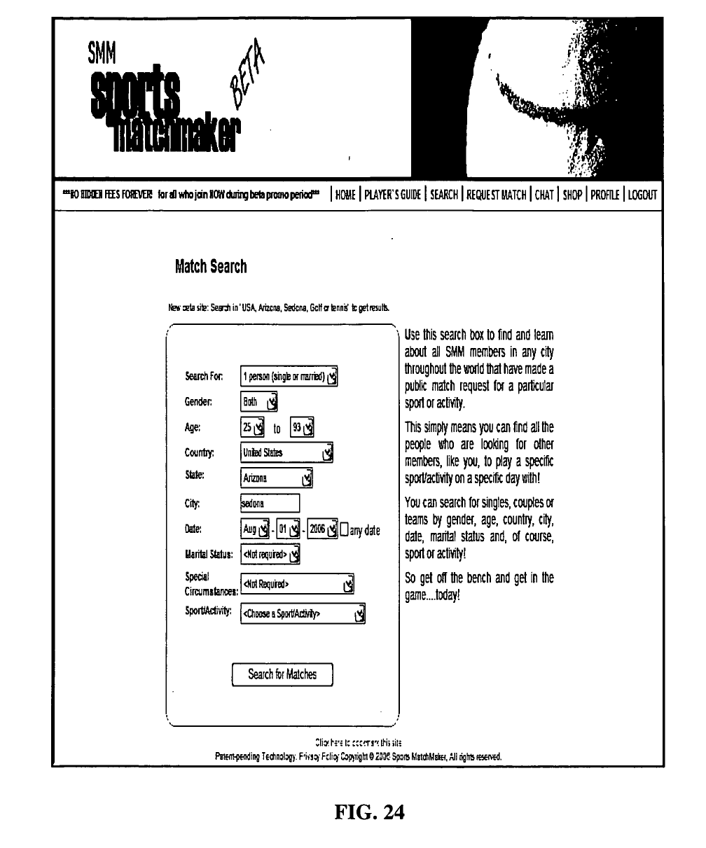

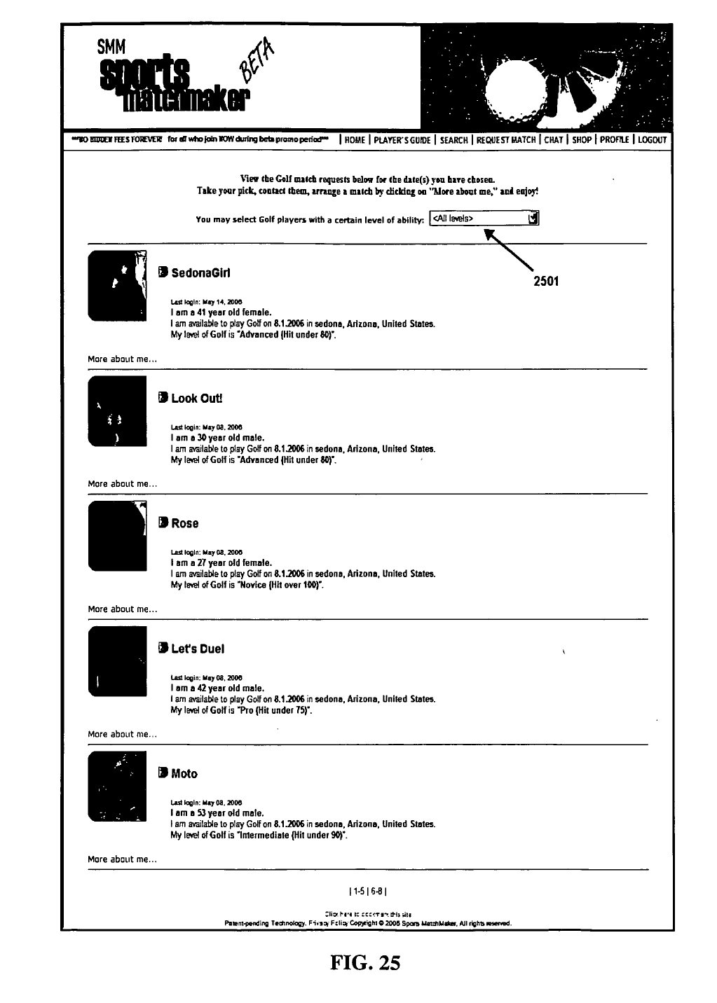

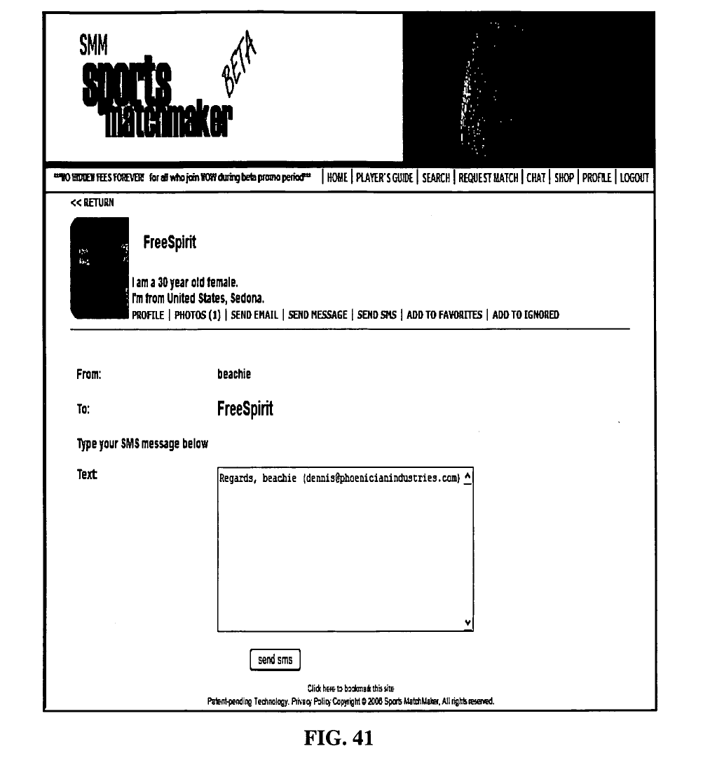

Preferably, functional component Match Search 305 provides a Registered User with the ability to input match criteria including sport/event, time frame, and location as well as selected personal criteria, including age, gender, and marital status. After inputting match criteria, a Registered User may then search Matchmaker Database 320 for all Registered Users having input match requests that meet such criteria, as shown in FIG. 24 (at least herein embodying computer interface means for permitting entry on behalf of such at least one second participant first searchable criteria for proposed matching of such at least one proposed joint event; and at least herein embodying computer processing means for retrieving from said computer database means such proposed-event information matching such first searchable criteria). As used herein, time frame may refer to a specific date and time, a range of dates, a range of times, or one or more specified days of the week, month, etc. FIG. 25 provides an example of match requests that fit the inputted criteria. Upon reading the teachings of this specification, those with ordinary skill in the art will now understand that, under appropriate circumstances, considering issues such as the need for partial matching of search criteria, etc., other selection arrangements, such as, for example, using of heuristic selection methods for partial or approximate matching, etc., may suffice. Upon reading the teachings of this specification, those with ordinary skill in the art will now understand that, under appropriate circumstances, considering such issues as user preference, competitive requirements, etc., an entity value, such as an employer, a company, a hotel, a sports club, a fitness center, or other organization, etc., may be searchably associated with a Registered User and may be used as a search criteria. Preferably, the search results may be refined by specifying the desired skill level as shown at the top of FIG. 25. Preferably, a Registered User may then view the profile (See FIG. 19) and optional photo (See FIG. 21) of each Registered User who has made a match request matching the search criteria. A dialog between the Registered Users may then be initiated using either email (See FIG. 22), Instant Messaging (“IM”) (See FIG. 23), or digital mobile phone-based text messaging (“SMS messaging”) (See FIG. 41) where the Registered Users may agree to meet in person for the sporting or social event.

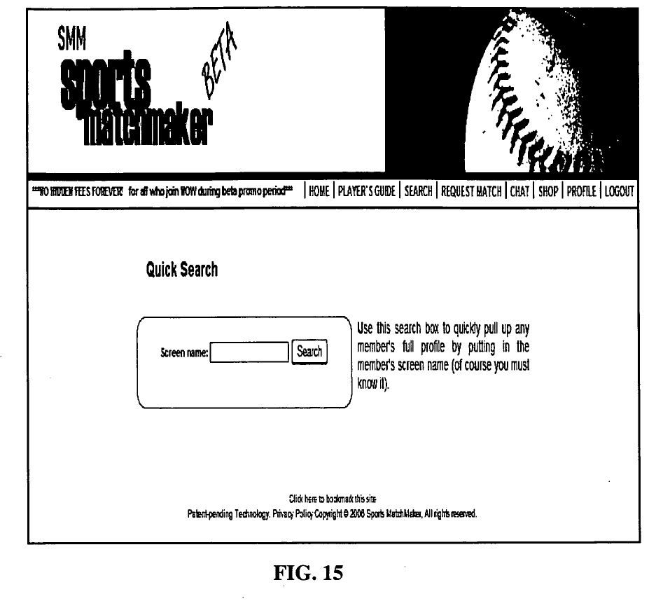

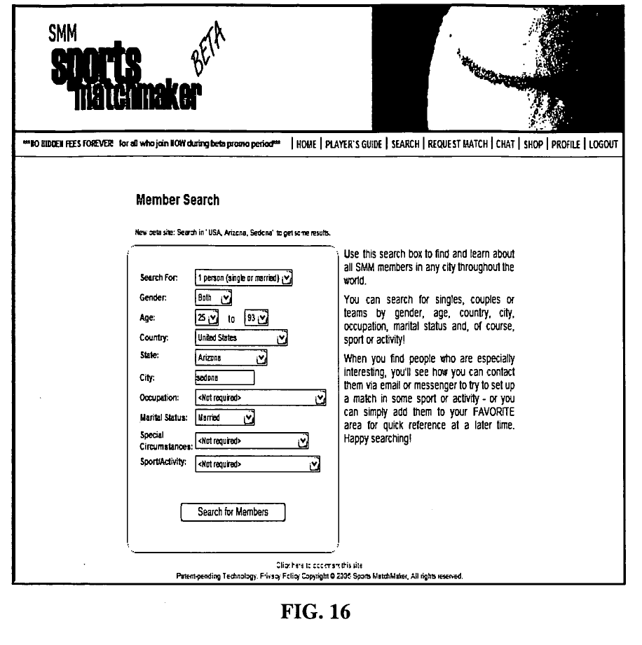

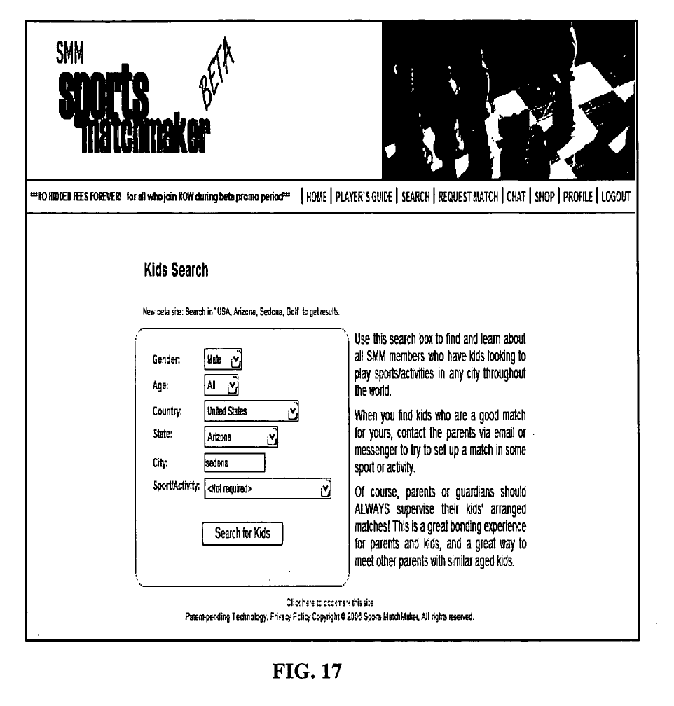

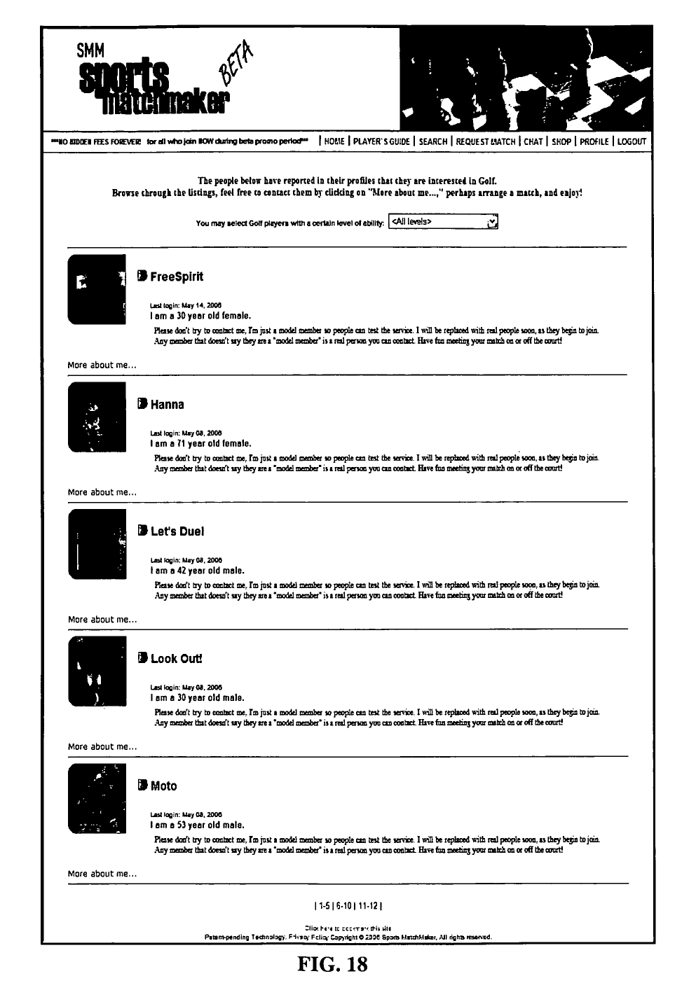

Preferably, Member Search 306 permits Registered User 202 to search Matchmaker Database 320 using the member criteria as shown in FIG. 16. Preferably, a search may be performed for singles, couples, or teams, as shown. Those members matching the search criteria are listed for review as shown in FIG. 18. Upon reading the teachings of this specification, those with ordinary skill in the art will now understand that, under appropriate circumstances, considering issues such as the need for partial matching of search criteria, etc., other selection arrangements, such as, for example, using of heuristic selection methods for partial or approximate matching, etc., may suffice. Preferably, the profile (See FIG. 19) and photo (See FIG. 21) may be viewed by Registered Users. A dialog between Registered Users may then be initiated using either email (See FIG. 22), Instant Messaging (IM) (See FIG. 23), or digital mobile phone-based text (SMS) messaging (See FIG. 41). Preferably, Registered Users may also search for kids (See FIG. 17), which will return a list of singles or couples who have kids matching the search criteria. Preferably, a Registered User may also search for a member solely using a screen name as shown in FIG. 15.

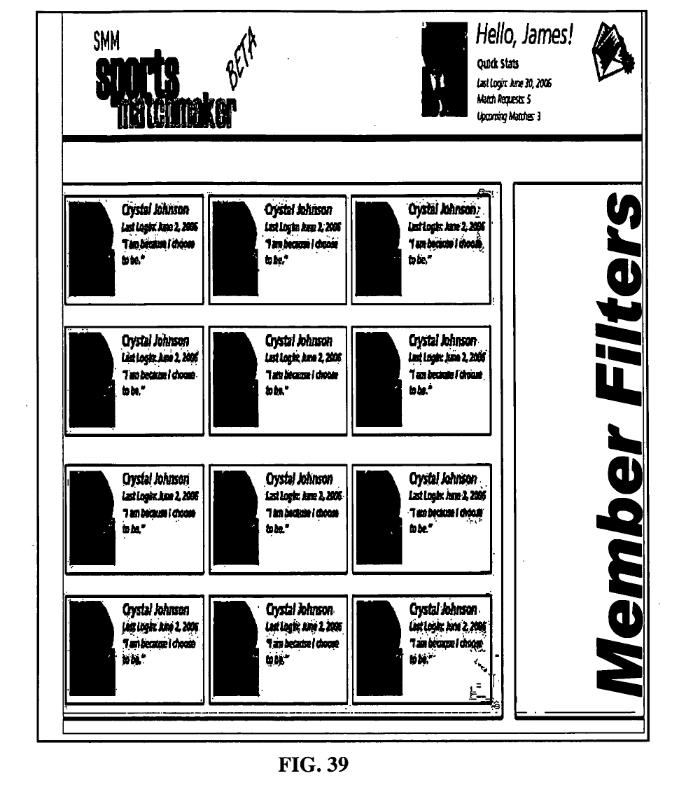

According to an alternate preferred embodiment of the present invention, alternate Search Results displaying all members' images for members whose inputted match information match the search criteria (See FIG. 39) may be presented to a Registered User. Preferably, when Registered User moves the cursor over each image, the profile information related to that member will be displayed. Preferably, when a Registered User slides the “ability level” bar, some images will fade in or out depending on each member's stated ability, etc. All these features will affect the speed and efficiency of searching that a Registered User will experience.

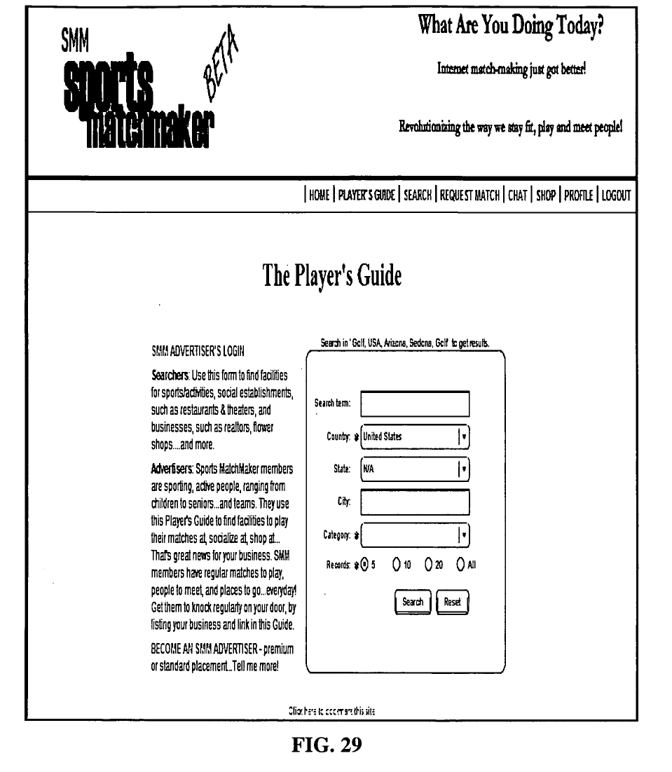

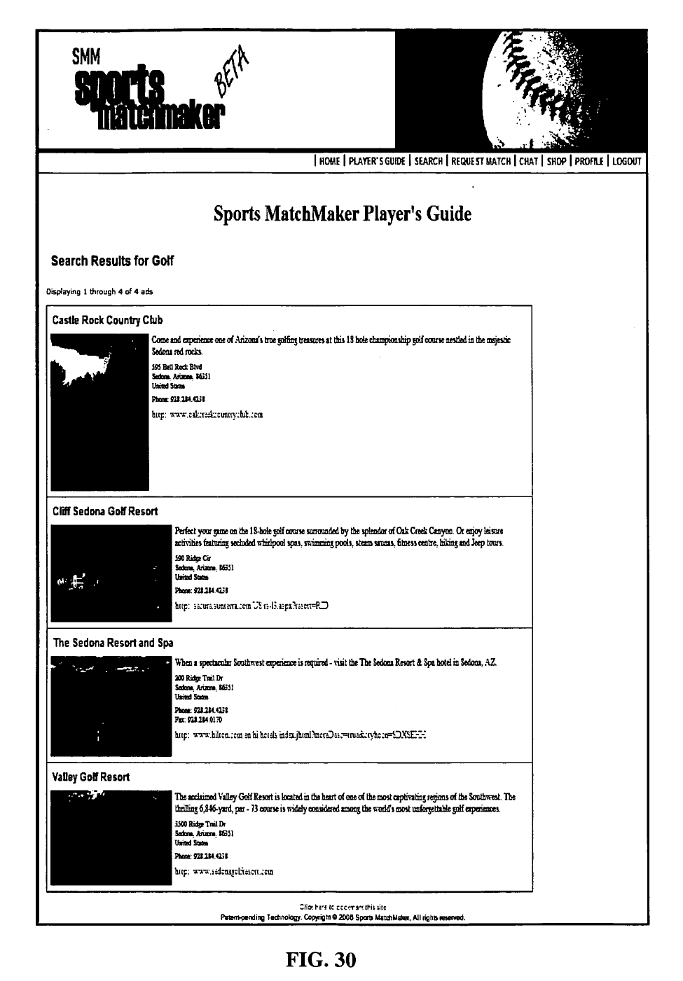

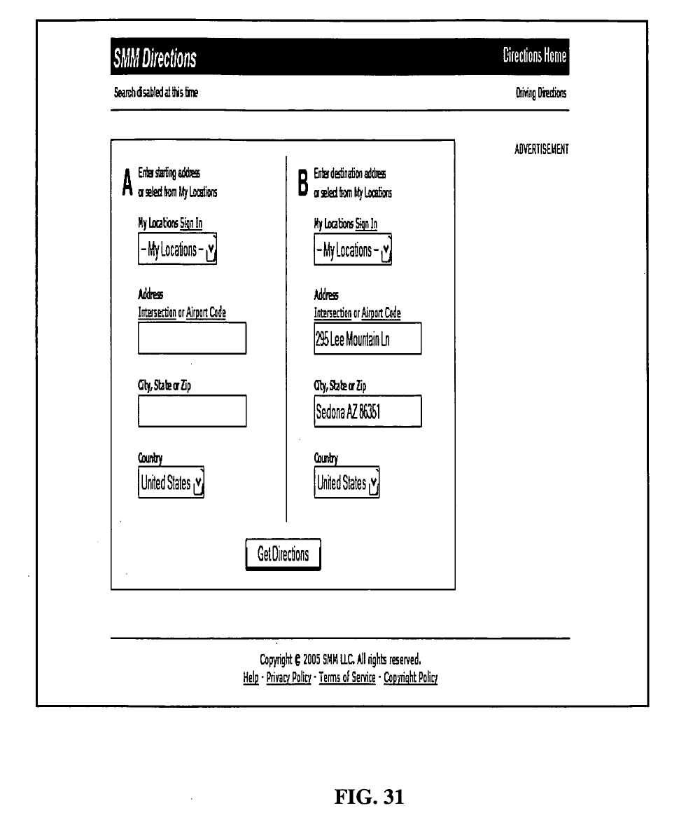

Directory Search 307 preferably permits a Registered User to identify and select a location at which a desired sporting or social event may be conducted. As shown in FIG. 29, a Registered User may search by business name or request a list of business entities within a category. FIG. 30 provides an example of the results of a search within the “Golf” category. Preferably, a Registered User may then view more detailed about the business entity or request a map and driving directions to the business entity as shown in FIG. 31.

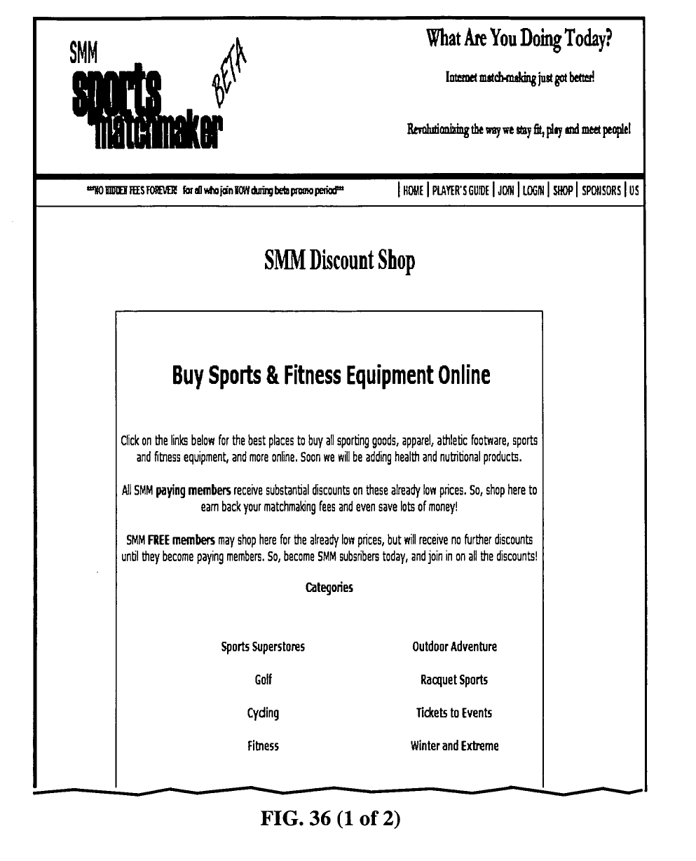

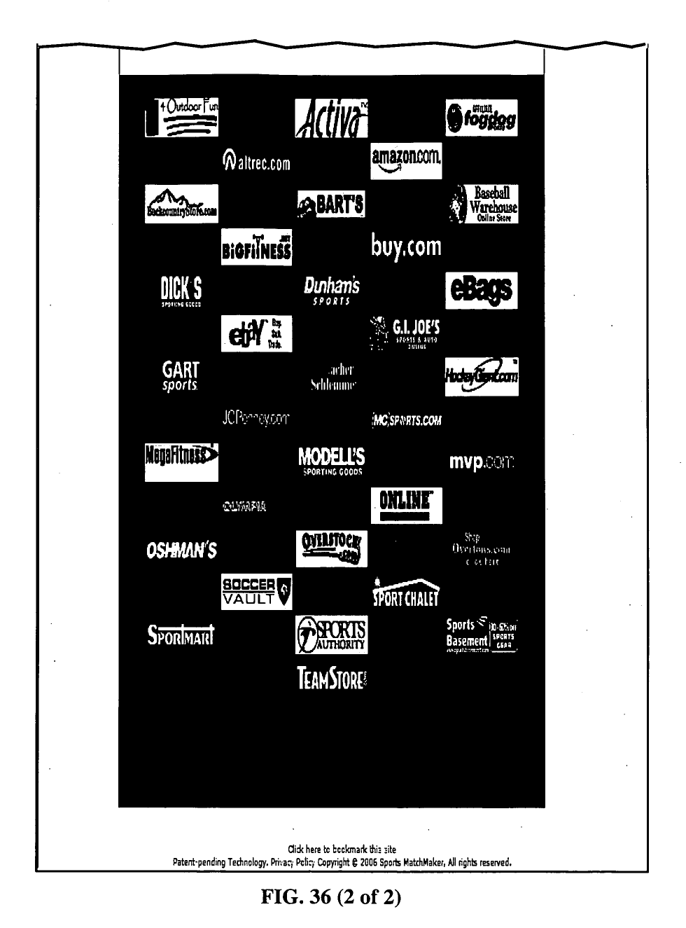

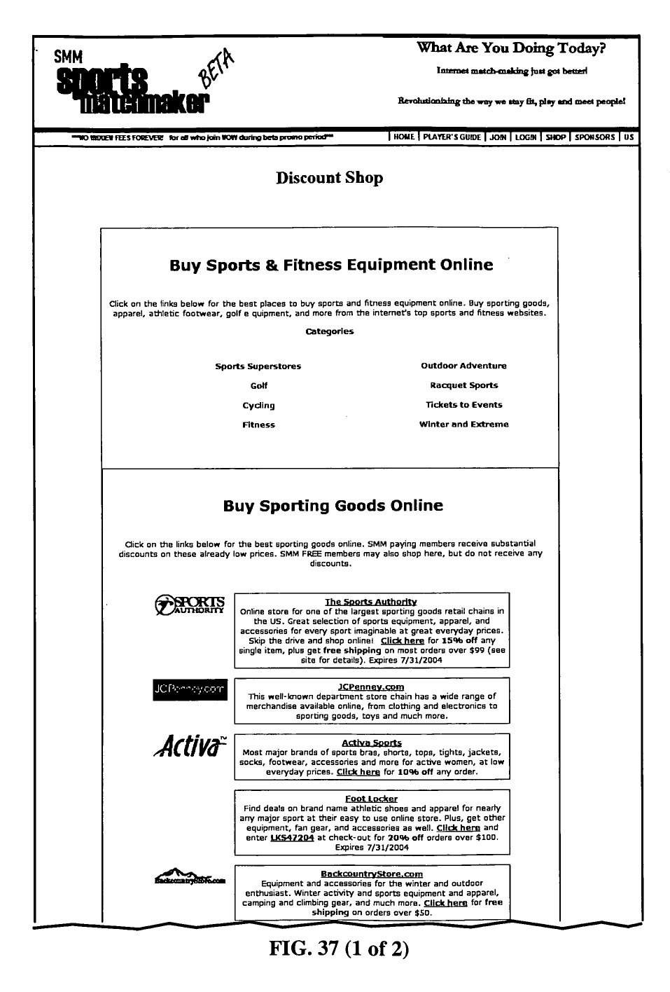

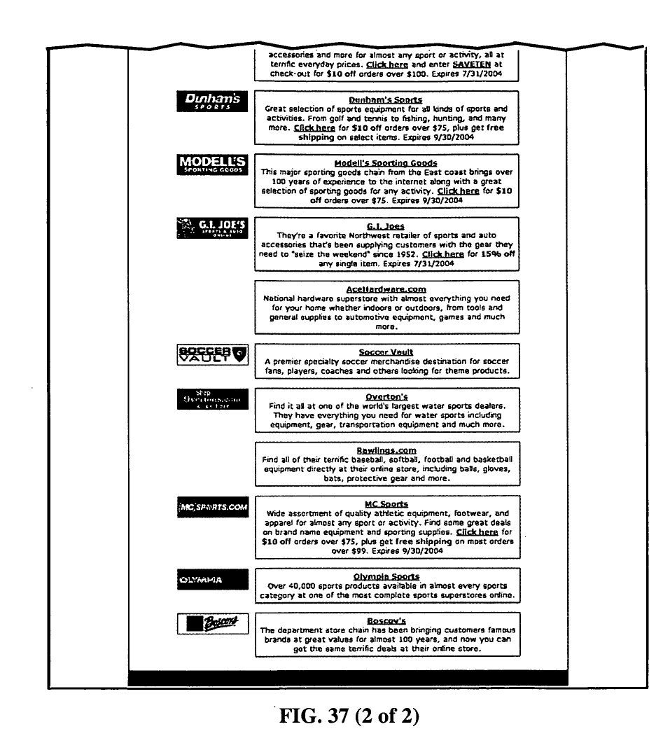

Functional component Shopping 308 preferably permits Registered User 202 to identify and select an online retailer as shown in FIG. 36 and FIG. 37. As shown in FIG. 37, preferably a Registered User may select a link to a desired online retailer and make a purchase, often at a discount. Preferably, the discounts provided are only available to Registered Users as a benefit of membership.

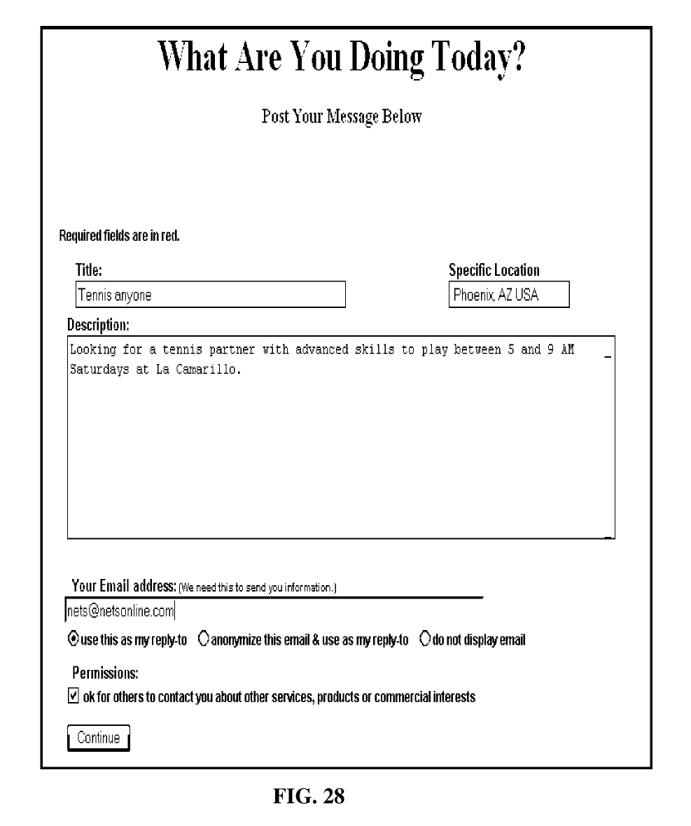

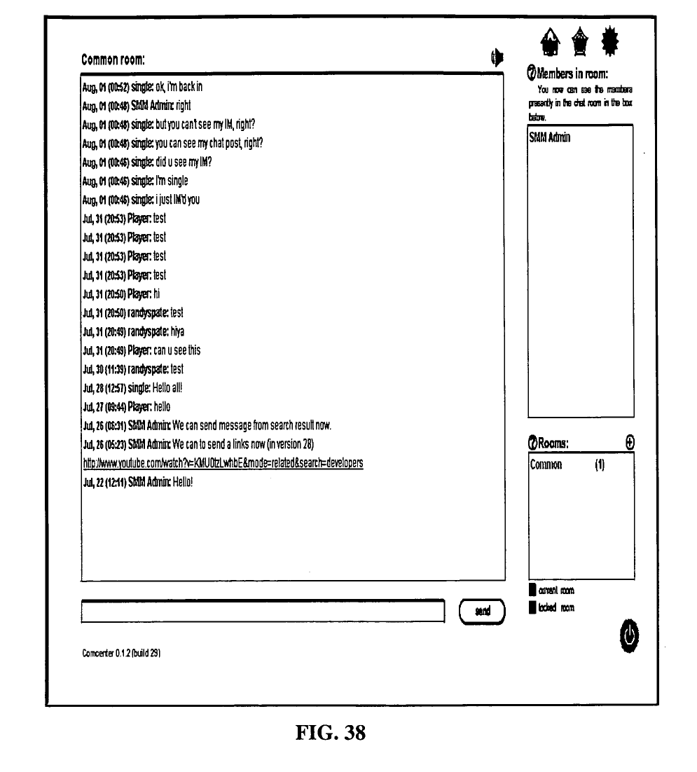

Functional component Online Forums 309 preferably comprises an online chat system, one or more BLOGs, and online forums/bulletin boards made available to Registered Users. FIG. 22 shows an example of a preferred email message screen. FIG. 23 presents an example of a preferred Instant Message screen. FIG. 28 provides an example of a preferred screen used to post a new message to a bulleting board. FIG. 38 illustrates an example of a preferred chat screen.

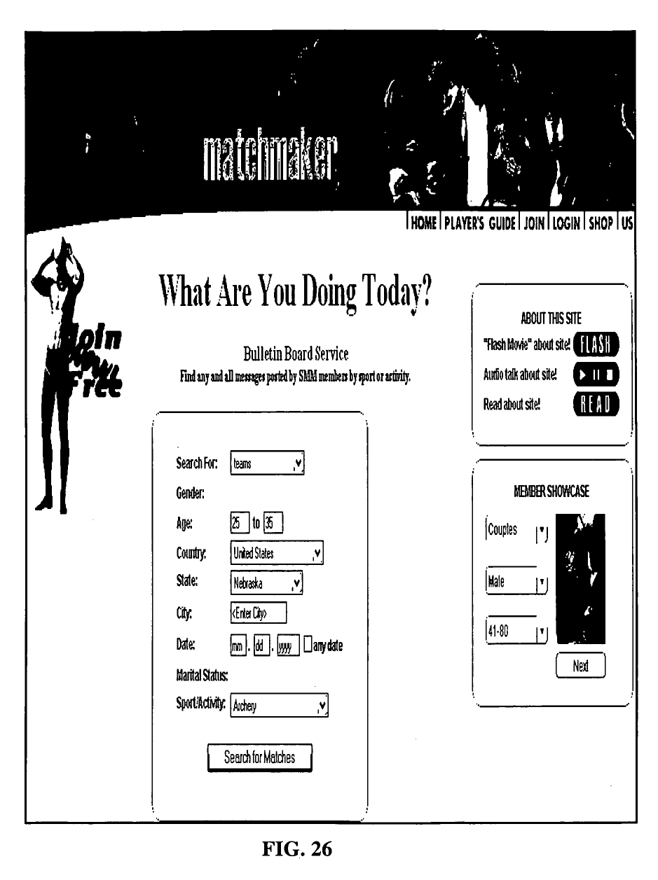

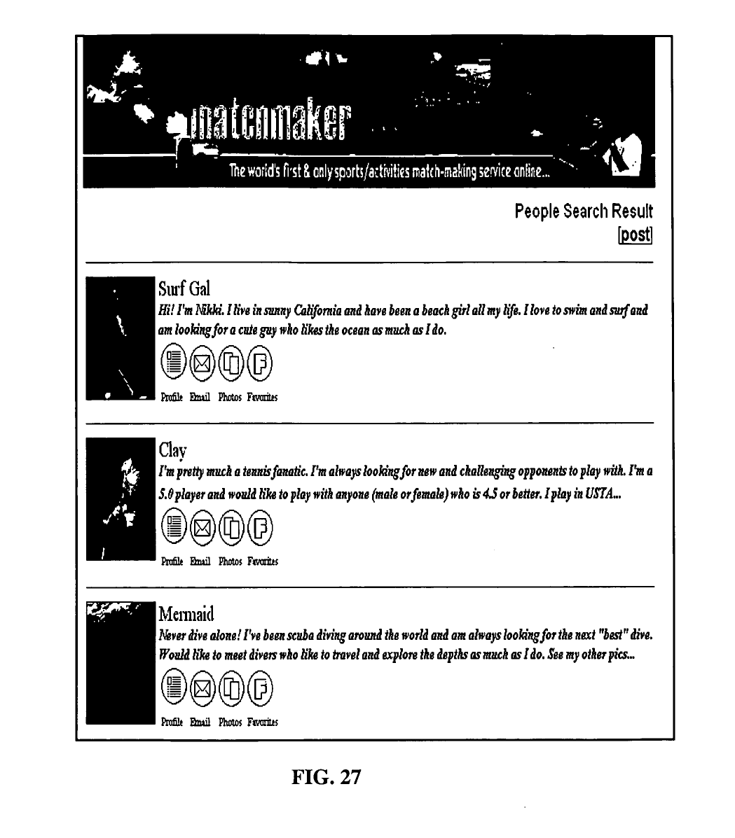

Functional component Bulletin Board Search 310 preferably permits a Registered User to search for messages posted to a bulletin board that meet the search specified criteria, as shown in FIG. 26. Preferably, the search process combines a search of the profile portion of Matchmaker Database 320 and text match searching of bulletin board messages. Upon reading the teachings of this specification, those with ordinary skill in the art will now understand that, under appropriate circumstances, considering issues such as the need for partial matching of search criteria, etc., other selection arrangements, such as, for example, using heuristic selection methods for partial or approximate matching, etc., may suffice. Preferably, all bulletin board messages matching the search criteria are displayed as shown in FIG. 27.

Functional component Email/IM 311 preferably provides the functionality necessary to support email and Instant Messaging between Registered Users. Additionally preferred functions include the use of screen names provided by Registered Users rather than actual email addresses or Instant Message handles.

Functional component Affiliates 312 preferably provides tracking and accounting for visitors who are referred from affiliate Web sites who then become Registered Users. Preferably, the business entities operating the affiliated Web sites have agreed to include a link to Matchmaker Web site 300 which can be used by Unregistered Users. Preferably, an Affiliate calculates any remuneration owed to each business entity as a result of a referred Unregistered User becoming a Registered User.

Functional component User Account Information 313 preferably comprises all the necessary administrative functions to manage a database of members including tracking and collection of membership fees.

Functional component Partner's Account Information 314 preferably comprises all the necessary administrative functions to manage a database of affiliate, advertising, and shopping partners. Preferably, these functions include the tracking and collection of fees due to Web site Manager 201 and tracking and payment of fees due to affiliate partners for new member referrals.

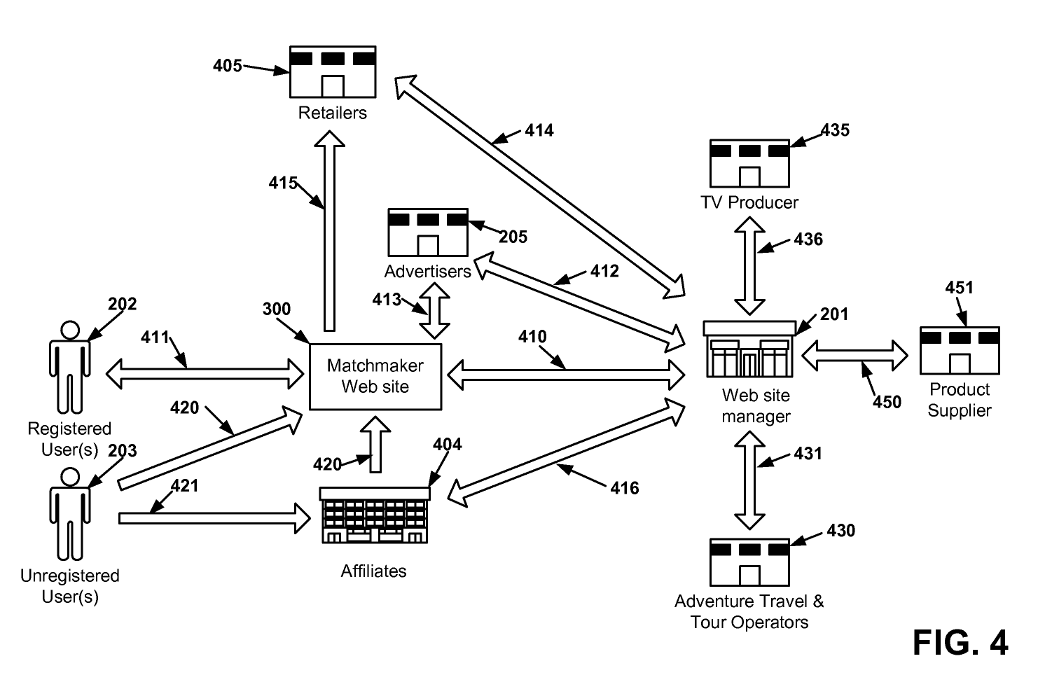

FIG. 4 shows a summary schematic of the primary entities and their relationships associated with the instant system and method, according to the preferred embodiment of the present invention. Preferably, Web site manager 201 establishes and manages Matchmaker Web site 300 in step Manage Web site 410.

Preferably, in step Establish Advertiser Relationships 412 Web site Manager 201 offers opportunities to be listed in directory of venues (Player's Guide) for sporting and social events. Preferably, Advertiser 205 uses Advertiser Set Up 303 to select from one of the plans offered, complete its directory entry, and set up the method of payment. Preferably, each Advertiser 205 also has the opportunity to become an Affiliate 404, which preferably entitles Advertiser 205 to discounted advertising rates and other benefits. Advertiser 205 preferably comprises sporting venues such as golf courses, tennis clubs, health clubs, martial arts studios, paintball facilities, or any other location that provides a venue for a sporting event. Additionally, Advertiser 205 preferably comprises social venues such as movie theaters, restaurants, campgrounds, and hotels. In addition Advertiser 205 preferably comprises businesses that provide services and products that support sporting, athletic, and social activities.

Preferably, Web site Manager 201 will selectively contract with Advertiser 205 or other venues including hotels, restaurants, and clubs to cater and manage sporting and social events such as tennis tournaments, bridge tournaments, and similar competitions. In turn, preferably Web site Manager 201 will promote each planned tournament via email targeted to selected members within the Matchmaker Database 320 who, for instance, have indicated an interest in planned sporting or social events. Preferably, Web site Manager 201 will accept reservations and entry fee payments for planned events.

Preferably, in step Establish Retailer Relationships 414, Web site Manager 201 will offer Web site links to Retailer 405 to permit Registered User 202 to purchase products and services from Retailer 405. In return, Retailer 405 preferably offers Registered User 202 a discount on some or all its products or services. In summary, the intent is to use the increased interest in shopping with Retailer 405 to provide an incentive for visitors to become Registered Users.

Preferably, in step Establish Affiliate Relationships 416, Web site Manager 201 offers a commission to each Affiliate 404 for each visitor that comes to Matchmaker Web site 300 from the Web site of Affiliate 404 who then becomes a Registered User. Preferably, each Affiliate 404 agrees to place a link on its Web site and to promote Matchmaker Web site 300. As noted, Affiliate 404 may also become Advertiser 205 and receive reductions in costs for the placement of entries in directory of venues. Affiliate 404 preferably comprises the same business that may be Advertiser 205, but in addition preferably comprises Web sites which are devoted to both professional and amateur sporting events. Additionally Affiliate 404 preferably comprises Web sites focused on nutritional and performance improvement products.

Preferably, in step Establish Travel Relationships 431 Web site Manager 201 preferably will arrange to promote and advertise products and services offered by Adventure Travel and Tour Operators 430 domestically and internationally. Preferably, Web site Manager 201 will, in turn, receive referral fees or commissions for members that use the advertised products and services and optionally advertising fees associated with ads presented on Matchmaker Web site 300.

Preferably, in step Establish TV Relationships 436, Web site Manager 201 preferably will arrange with TV Producer 435 to promote and advertise at least one “reality” television program oriented toward using competitors chosen from members in Matchmaker Database 320 for national and international competitions. Preferably, in turn, the reality television program will promote that only members (singles, couples, and teams) will be chosen from the members in Matchmaker Database 320. Preferably, Web site Manager 201 will, in turn, receive increased registrations of members thus increasing substantially the number of members in Matchmaker Database 320, which in turn increases demand for the other services and products offered in and through Matchmaker Web site 300.

Preferably Web site Manager 201 will use Registered Users 202 stored in the Matchmaker Database 320 as a source for advertising and organizing tournaments in all kinds of sports/activities. Advertisers 205 (such as tennis clubs, golf clubs, etc.) will preferably host and run in local areas throughout the globe. Prizes will preferably be supplied by Web site Manager 201. Preferably the winners of first round tournaments are then eligible to play in the second round tournaments, and so on, until the final championship match or event. Preferably, TV Producer 435, as a business partner of Web site Manager 201, such as a FOX Sports, preferably will send camera crews to various cities during the rounds of tournaments to conduct interviews and capture footage of participants, matches, etc.—like the talent program “American Idol” does during the audition process. Then, the final championships will preferably the core content of a reality television program aired by TV Producer 435. The benefit is that Web site Manager 201 can use the Advertisers 205 (such as athletic club facilities) nationwide, which are in the business of holding tournaments, to recruit and bring in revenue and new members to the Advertiser 205 (preferably Web site Manager 201 registers all tournament entrants and collects the fees online). Also, these Advertisers 205 (athletic clubs) will actually compete to hold the Web site Manager 201 tournaments since there is a likelihood that TV Producer 435 camera crews may visit and give the Advertisers 205 exposure by collecting footage of the tournament. These tournaments constantly being run year round are preferably the eliminating and qualifying process for the ultimate reality television program. When the reality show is advertised, they will draw new members to Web site Manager 201, since tournament participants must be Registered Users 202, and, as many people desire to appear on a reality television program, they will most likely register for the Web site Manager 201 local tournaments for such an opportunity.

Preferably, in step Establish Supplier Relationship 450 Web site Manager 201 will arrange with at least one Product Supplier 451 to provide products for resale by Web site Manager 201. Preferably, Matchmaker Web site 300 will provide ecommerce functions necessary for Registered User 202 to purchase and pay for the offered products. Preferably, the offered products will comprise nutrition products generally associated with health and fitness. Upon reading the teachings of this specification, those with ordinary skill in the art will now understand that, under appropriate circumstances, considering issues such as market changes and customer demand changes, other types of products may be offered for sale, such as, for example, sporting equipment, clothing, etc.

Registered User 202 preferably completes login to Matchmaker Web site 300 to initiate the step Use Matchmaker Web site 411. Preferably, Registered User 202 agrees to pay a periodic fee in return for access to all functions available through Matchmaker Web site 300, including Match Requests 304, Match Search 305, Member Search 306, Online Forums 309, Bulletin Board Search 310, and Email/IM 311. In step Find Activity Location 413, Registered User 202 preferably uses Advertiser Search 307 to select at least one activity location. In step Purchase Goods and Services 415, Registered User 202 preferably uses Shopping 308 to find a retailer from which to purchase the desired products and services.

Preferably, Unregistered User 203 may visit Matchmaker Web site 300 directly and become a member by completing the User Registration and Login 301 and agreeing to pay a periodic fee as depicted by step User Access and Registration 420.

Preferably, in step Visit Affiliate Web site 421, Unregistered User 203 may visit the Web site of Affiliate 404 which presents information about Matchmaker Web site 300 and a link to Matchmaker Web site 300. Preferably, selecting the link will present Registration and Login 301 to Unregistered User 203 which begins step User Access and Registration 420, further described above.

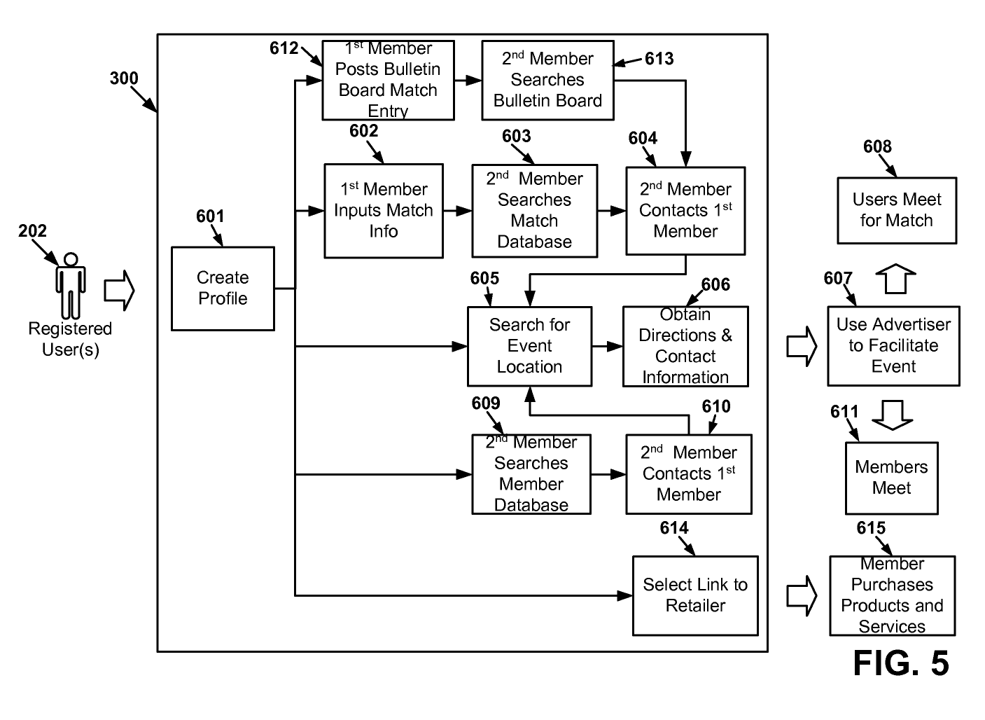

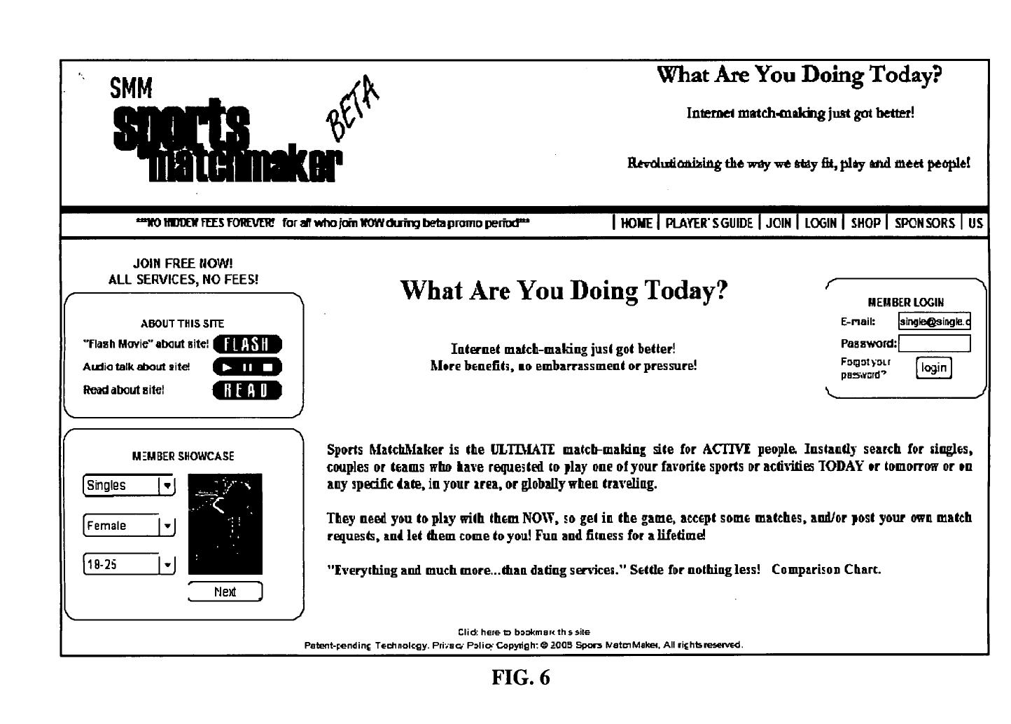

FIG. 5 shows a summary schematic of the primary steps which may be completed in the instant system and method, according to the preferred embodiment of the present invention. Preferably, each visitor must register and create a profile to utilize the functions of Matchmaker Web site 300 in step Create Profile 601. Preferably, a new member completes the registration form (FIG. 8) indicating whether the registration is for a single, a couple, or a team by completing the field “You Are:” which then takes the user to the appropriate profile form (FIG. 9, FIG. 11, or FIG. 12 for a single, couple, and team, respectively) and where the user completes at least the required fields which include demographic data (such as age, gender, marital status, etc.), contact information (such as email address), and the user's preferred sports/activities pastimes and related skill level (at least herein embodying computer interface means for permitting database entry, on behalf of such at least one first participant, of at least one first skill level of such at least one type of proposed joint event; at least herein embodying computer database means for searchably storing participant personal profile information wherein such participant personal profile information comprises at least at least one unique identifier, such at least one type of such proposed joint event, such of at least one first skill level of such at least one type of proposed joint event, demographic information, contact information; and at least herein embodying computer interface means for database entry on behalf of such at least one first participant such personal profile information; at least herein embodying wherein such personal profile information further comprises at least two of the following: children information; participant background information; personality traits information; favorite foods information; preferred music information; and at least one image). Preferably, each Registered User 202 may have more than one sports/activities pastime. Preferably, Registered User 202 may then enter the member's area (FIG. 15, FIG. 16, FIG. 17 and FIG. 24) and begin searching for members and matches. Preferably, when Registered User 202 logs out of the Matchmaker Web site 300 the first time, the Registered User cannot log in again until the Registered User receives an initiation email and activates the membership by clicking a link provided in such email. If Registered User 202 tries to log in before receiving the initializing email, the site will automatically provide them with a button to send out, or deliver, another activation email. Registered User 202 is then directed to look for the email and activate the membership by clicking the link provided in the email. Once Registered User 202 activates his/her membership, Registered User 202 may log in and begin searching via all search boxes for adult members, Match Requests, members by screen name and adults who have kids broken down by gender, age, sports played, and level of ability (FIG. 15, FIG. 16, FIG. 17, and FIG. 24). Preferably, Registered User 202 cannot contact another member or make a match request (FIG. 13) until the Registered User becomes a paying member.

As shown, preferably in step First Member Inputs Match Info 602, Registered User 202, as a paid member, makes at least one Match Request which is a public request (offer) to play a match with others in a particular sport/activity in a particular city, on a specific date, with a person having a particular gender, martial status (couple or team), and particular skill level (FIG. 13 and FIG. 14). As depicted, Registered User 202 may indicate a preference for the day of week by selecting the desired Day of Week Check Boxes 1303. Preferably, use of Day of Week Check Boxes 1303 permits searching by day of week. Preferably, sport/activity match requests (offers) may include any time and location based event, such as playing a round of golf, fishing, watching a sporting event, going to a movie, or having dinner.

Once at least one match request is posted to Matchmaker Database 320, preferably another Registered User 202 may search for a match that meets his/her criteria as shown in step Second Member Searches Match Database 603. Preferably, Registered User 202 uses the Match Search Screen (FIG. 24) to query Matchmaker Database 320. Preferably, all member profiles associated with Match Requests satisfying the search criteria are presented in the Search Results screen (FIG. 25) (at least herein embodying computer processing means for retrieving from said computer database means such proposed-event information matching such second searchable criterion). As shown, Registered User 202 may then filter the displayed Match Requests by selecting a skill level from Skill Level Drop Down 2501 (at least herein embodying computer interface means for permitting entry on behalf of such at least one second participant at least one second searchable criterion for proposed matching with such at least one skill level of such at least one type of proposed joint event).

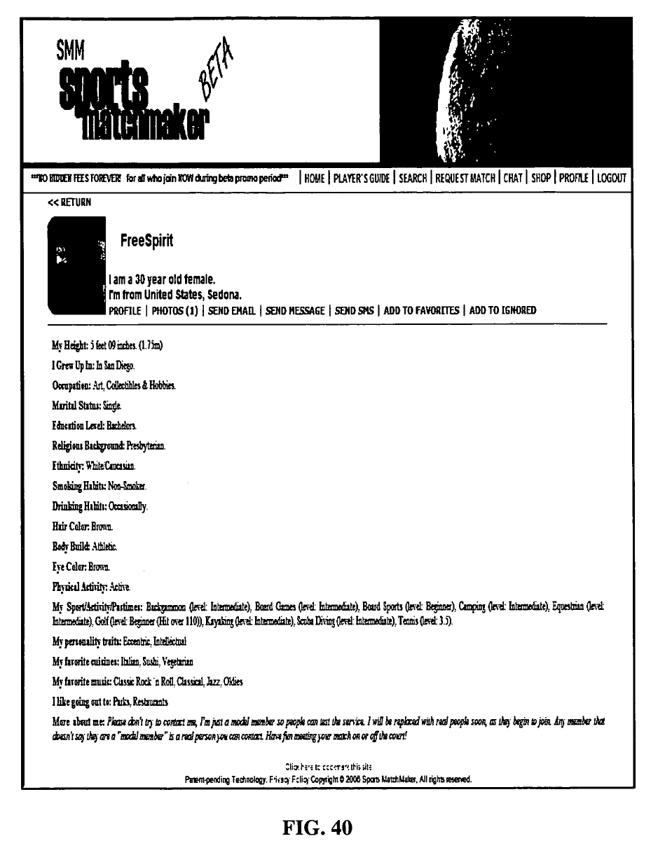

Once Registered User 202 determines that a listed profile of a member with a matching Match Request is desirable, in step Second Member Contacts First Member 604, preferably, Registered User 202 views (requesting) the details of the member's profile on the Member Profile screen (FIG. 19). If the selected member is still desirable, Registered User 202 (as a paid member) may contact the other member using Instant Messaging (FIG. 23), email (FIG. 22), digital mobile phone-based text messaging (SMS messaging) (See FIG. 40 and FIG. 41), the chat room system (FIG. 38), or the bulletin board system (FIG. 28) by selecting the appropriate link on the Member Profile screen (at least herein embodying computer processing means for assisting such at least one second participant to communicate with such at least one first participant). Preferably, in all cases, communication between members is done using the member's “screen name” rather than their actual email addresses or mobile phone numbers to protect privacy and ensure security (at least herein embodying computer processing means for assisting non-disclosure of first contact information of such first participant to such second participant; at least herein embodying computer processing means for assisting non-disclosure of second contact information of such second participant to such first participant; and at least herein embodying wherein the step of assisting such at least one second participant to communicate with such at least one first participant is accomplished with text messaging on digital mobile phones).

The business advantage that Matchmaker Web site 300 provides is that Registered Users 202 may immediately (preferably with one click) find the main object that Registered Users 202 are searching, namely, people. Statistics show that the faster Registered Users 202 can find what they are looking for on Matchmaker Web site 300, the more successful the Matchmaker Web site 300 will be.

Preferably, the present Matchmaker Web site 300 immediately connects Registered Users 202 together using the least amount of computing resources as possible and providing more than one method of beginning the process of making a match. Registered Users 202 will then be able to use their computer resources to communicate further with each other, if they so choose.

Once both Registered Users 202 have agreed to meet for a match a location for the match play must be determined. If a location must be found, Registered User 202 preferably searches the directory of venues (Player's Guide) to view information about the variety of locations available, in step Search for Event Location 605. As shown in FIG. 29, Registered User 202 may search by business name or category or select a category from those displayed. The resulting list of venues is presented in a listing of the directory entries fitting the search criteria (FIG. 30).

In step Obtain Directions and Contact Information 606, preferably selecting one of the directory entries presents additional information about the venue, such as costs, reservation requirements, and hours of operation. Additionally, Registered User 202 may choose to obtain a map or driving directions by selecting the Map link which permits Registered User 202 to complete the map form as shown in FIG. 31.

After selecting a venue, Registered User 202 will complete the necessary arrangements to conduct the match at the agreed date and time in step Use Advertiser to Facilitate Event 607.

In step Users Meet for Match 608 individuals, couples or teams, as the case may be, meet and complete the planned activity.

Referring again to FIG. 5, step Second Member Searches Member Database 609, Registered User 202 may search for another Registered User 202 for the purpose of meeting socially by using one of the member search screens, Quick Search (FIG. 15), Member Search (FIG. 16) or Kid Search (FIG. 17). Preferably, Registered User 202 may search by any combination of the search fields provided including singles, couples, or teams (at least herein embodying computer interface means for permitting entry on behalf of such at least one second participant at least one third searchable criteria for proposed matching of such personal profile information). All members matching the search criteria are preferably displayed on the Member Search Results screen (FIG. 18) (alternate Member Search Results screen, (See FIG. 39) may also be displayed) (at least herein embodying computer processing means for retrieving from said computer database means such first personal profile information matching such third searchable criteria).

Once Registered User 202 determines that a listed member is desirable, step Second Member Contacts First Member 610, preferably, Registered User 202 views the selected member's profile on the Member Profile screen (FIG. 19). If the selected member is still desirable, Registered User 202 (as a paid member) may contact the other member via Instant Messaging (FIG. 23), via email (FIG. 22), text messaging (SMS messaging) (See FIG. 40 and FIG. 41), the chat room system (FIG. 38), or the bulletin board system (FIG. 28) by selecting the appropriate link on the Member Profile screen.

Once both Registered Users 202 have agreed to meet socially a location must be determined. If a location must be found, Registered User 202 preferably searches the directory of venues (Player's Guide) to view information about the variety of locations available, in step Search for Event Location 605. As shown in FIG. 29, Registered User 202 may search by business name or category or select a category for those displayed. The resulting list of venues is presented in a listing of the directory entries fitting the search criteria (FIG. 30).

In step Obtain Directions and Contact Information 606, preferably, selecting one of the directory entries presents additional information about the venue, such as costs, reservation requirements, and hours of operation. Additionally, Registered User 202 may choose to obtain a map or driving directions by selecting the Map link which permits Registered User 202 to complete the map form as shown in FIG. 31.

After selecting a venue, Registered User 202 will complete the necessary arrangements to meet socially at the agreed date and time in step Use Advertiser to Facilitate Event 607.

Following selection and arrangement of a location the individuals, couples or teams, as the case may be, meet as shown in step Members Meet 611.

Referring again to FIG. 5, Registered User 202 may post messages to the bulletin board as shown in step First Member Posts Bulletin Board Entry 612. Preferably, when Registered User 202 decides to make a post to the bulletin board (FIG. 28), the message is automatically associated with the personal profile of the Registered User with a link so that the readers of the bulletin board message can click the link and read the profile of Registered User 202 who posted the message (at least herein embodying computer database means for searchably storing at least one bulletin board posting; at least herein embodying computer interface means for entry on behalf of such at least one first participant of such at least one bulletin board posting; and at least herein embodying computer processing means for associating such at least one such bulletin board posting with such at least one first participant). Preferably, bulletin board messages may be used to assist in setting up sports/activity matches or simply to make announcements.

In step Second Member Searches Bulletin Board 613, Registered User 202 may search for bulletin board messages preferably using search criteria as shown in FIG. 26 (at least herein embodying such fourth search criteria comprise: at least one type of proposed joint event; at least one proposed geographic area for such proposed joint event; at least one proposed time criterion for such at least one proposed joint event). Preferably, the entered search criteria will be used to search in combination through both the member profiles and the bulletin board messages to complete the request (at least herein embodying computer interface means for permitting entry on behalf of such at least one second participant at least one fourth searchable criteria for proposed matching with such personal profile information). As shown in FIG. 27, the search result preferably presents a list of all messages matching the search criteria (at least herein embodying computer processing means for retrieving such at least one bulletin board posting associated with such personal profile information matching such fourth search criteria). Registered User 202 may view the profile of Registered User 202 that posted the message by selecting the profile button and/or the photo button. Additionally, Registered User 202 may contact the individual by selecting the email button.

Referring again to FIG. 5, in step Select Link to Retailer 614, Registered User 202 may search for an online retailer to purchase a product or service. The preferred method for searching is shown in FIG. 36 and FIG. 37. Preferably, Registered User 202 selects a link to the desired Retailer 405 and makes a purchase through the Web site of Retailer 405 as shown in step Member Purchases Products and Services 615.

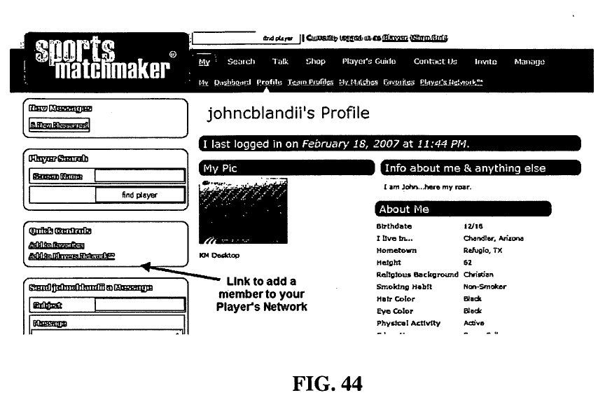

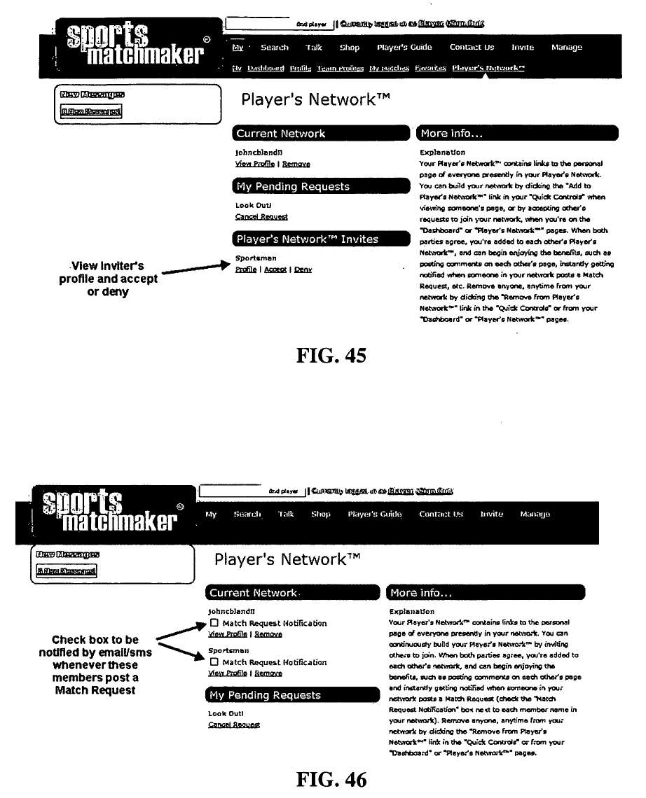

FIG. 44 shows an example of a user profile screen illustrating capability of member linking to a Player's Network according to a preferred embodiment of the present invention. Preferably using this user profile screen, a first Registered User, the inviter, may invite other Registered Users, the invitees, to become a “friend” of the first Registered User. Preferably, the invitee is notified of the invitation through the invitee's external email as well as through Matchmaker Web site 300 internal email, as shown in FIG. 45. The email invitation directs the invitee to the Player's Network page of the first Registered User, where the invitee may view the profile of first Registered User. Also from this page, the invitee may either “accept” or “deny” the invitation to join the inviter's Player's Network, as shown.

Once part of a Player's Network, the “friends” of the first Registered User may post “comments” on the first Registered User's 202 profile screen. Where the first Registered User (also herein called a “member”) does not want their user profile to be accessed by the public, in these situations, the first Register User may block the general public's access to the page by designating this page “private”. Once designated “private”, only “friends” of a Registered User will have access to personal pages not generally accessible to the general public. As shown in FIG. 44, a link under “Quick Controls” permits a first Registered User to invite a member to the first Registered User's Player's Network by clicking the link “Add to Players Network”.

FIG. 45 shows an example of the Player's Network screen of a user according to a preferred embodiment of the present invention. The Player's Network screen displays the “Current Network”, “My Pending Requests”, and “Players Network Invites” of a Registered User. The heading “Current Network” list the “friends” of a Registered User. The heading “My Pending Requests” lists those users who have requested to join the Player's Network of a Registered User. The heading “Player's Network Invites” lists those users who have invited a Registered User to join their Player's Network. From this screen, a Registered User may easily view an inviting member's profile or accept or deny the invitation with a single click, as shown.

FIG. 46 shows an example of the Match Request Notification Service of the Player's Network screen according to a preferred embodiment of the present invention. The Match Request Notification Service of the Player's Network screen allows a Registered User to receive all of the Registered User's match request details through email or SMS messaging that are posted by selected members of the Registered User's Player's Network. As shown in FIG. 46, a Registered User need only select a check box near a Registered User's screen name to receive an email or SMS message when those selected user's post Match Requests. This feature increases the chances of two members meeting when their schedules permit.

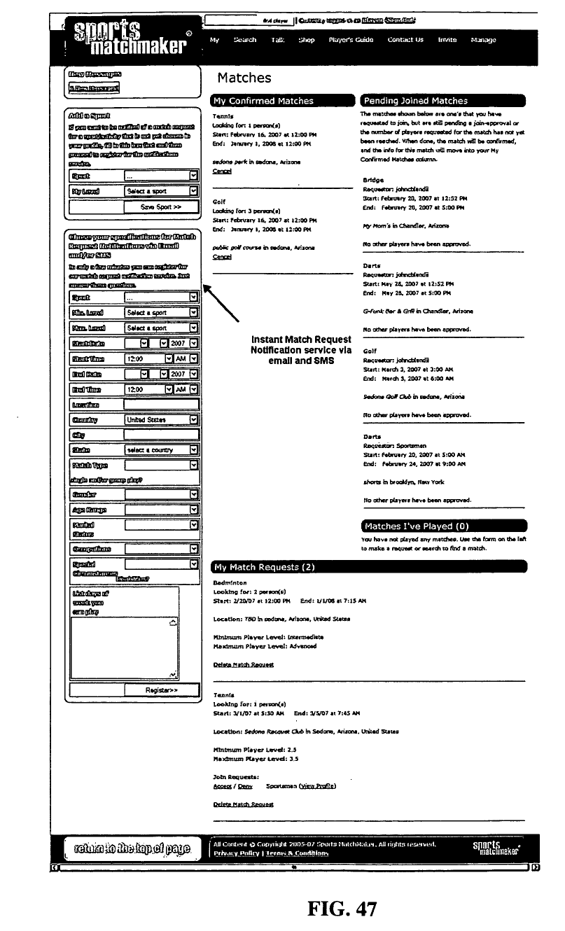

FIG. 47 shows an example of a Match Request Notification Service on the Matches screen according to a preferred embodiment of the present invention. The Match Request Notification Service allows a Registered User to receive all match request details from any other member, not just those members in the Registered User's Players Network, that match selected Registered User criteria. The Match Requests are sent to a member through email or SMS messaging. The criteria that may be selected include the following: sport, minimum level, maximum level, start date, start time, end date, end time, location, country, city, state, match type (single and/or group play), marital status, occupations, special circumstances (disabilities), and days of the week available to play. Once criteria are selected, a registered user will then be able to receive match requests that are compatible with the schedule, personality, etc., of the registered user. This feature permits a registered user to spend less time searching for matches, and more time setting up matches.

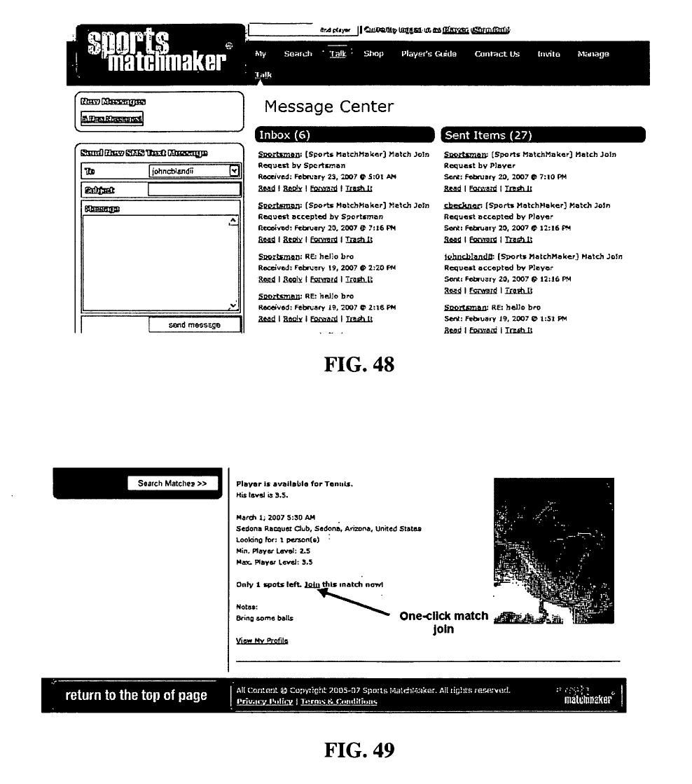

FIG. 48 shows an example of a Message Center screen according to a preferred embodiment of the present invention. The Message Center Screen permits a member to send SMS text messages anonymously through the Web site. The anonymous messaging feature is a security feature, and allows one to contact registered users without the need for exchanging personal information, such as telephone numbers. The anonymous messaging will additionally function with Internet enabled phones so that members may connect to the Message Center screen and send an SMS message while somewhere in the field. For example, a member may send a message to another user stating, “I'm at the courts. Are you on your way?”

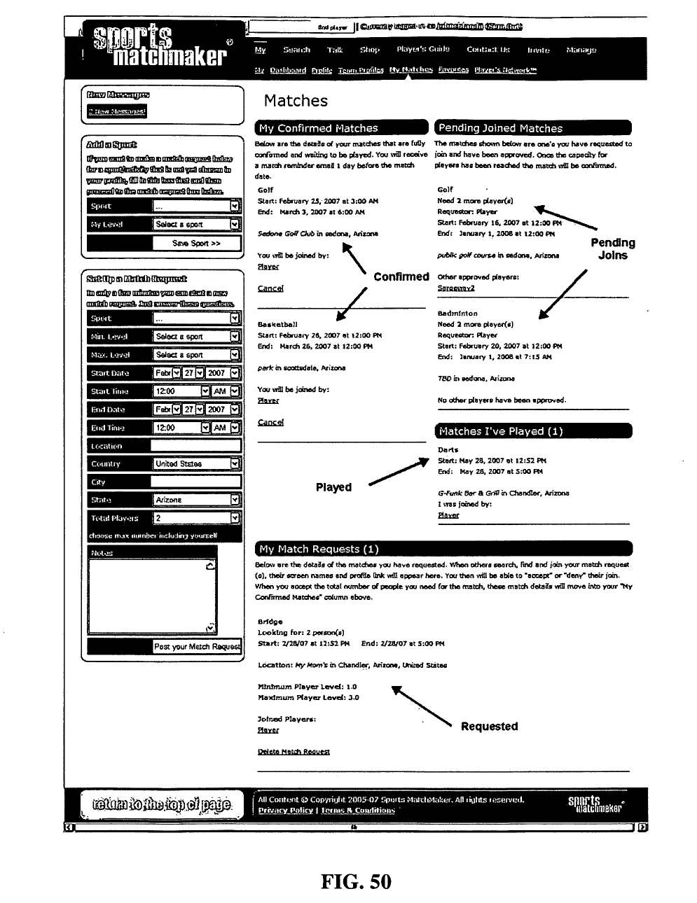

FIG. 49 shows an example of One Click Match Join feature according to a preferred embodiment of the present invention. The one-click match join permits members, requestees, to “join” a match or event requested by another member, the requester, by clicking once on a link. Once the link is clicked, both an internal and external email and/or a SMS message is delivered to the requestor of the match. The email and/or SMS message notifies the requestor that someone has asked to join the requestor's requested match. Further, once the “Join” link is clicked, the match details of the joined match appear in the requestee's “Pending Joined Matches” column (as shown in FIG. 50) for increased ease in viewing, reminding, and planning. After clicking the “Join” hyperlink, the Requestor is directed back to the Matches screen (as shown in FIG. 47) where the requestor may “accept” or “deny” the person that joined. The requestor “accept” or “deny” feature allows the requestor to monitor who is joining matches so that matches are not being filled with users who do not intend to play the joined matches. The requestor has the ability to specify some or all of the following information: sport, minimum level, maximum level, start date, start time, end date, end time, location, country, city, state, match type (single and/or group play, how many spots available), marital status, occupation, special circumstances (disabilities), and days of the week available to play. The requestor may also append notes to the match request.

FIG. 50 shows an example of a Match screen according to a preferred embodiment of the present invention. As shown, the Matches screen preferably displays the following headings: “My Confirmed Matches”, “Pending Joined Matches”, “Matches I've Played”, and “My Match Requests”.

The “My Confirmed Matches” heading lists details of confirmed matches that are waiting to be played. The sport, time, location, and user name of other members, or match attendees, are displayed, as shown. One day before each match, a match reminder email and/or SMS message is delivered to each match participant automatically. Such match reminder assists in match attendance by reminding users of the scheduled match. The “Pending Joined Matches” heading lists all matches that a member has “joined”, but is still pending a join-approval and/or the number of players requested for the match has not yet been reached. Once the pending joined matches are no longer pending, these match details will appear under the “My Confirmed Matches” heading.

The “My Played Matches” heading allows a user to view a match play history.

As described with respect to FIG. 49, the One Click Match Join allows a match requestor to “accept” or “deny” a match join request with one click, which automatically generates an internal and external email and/or SMS to the match joiner notifying the match joiner that match joiner's match join was accepted or denied by the match requester. If the join was accepted, and when the total number of participants has joined and been accepted, then the match details move to all participant's “Confirmed Matches” column.

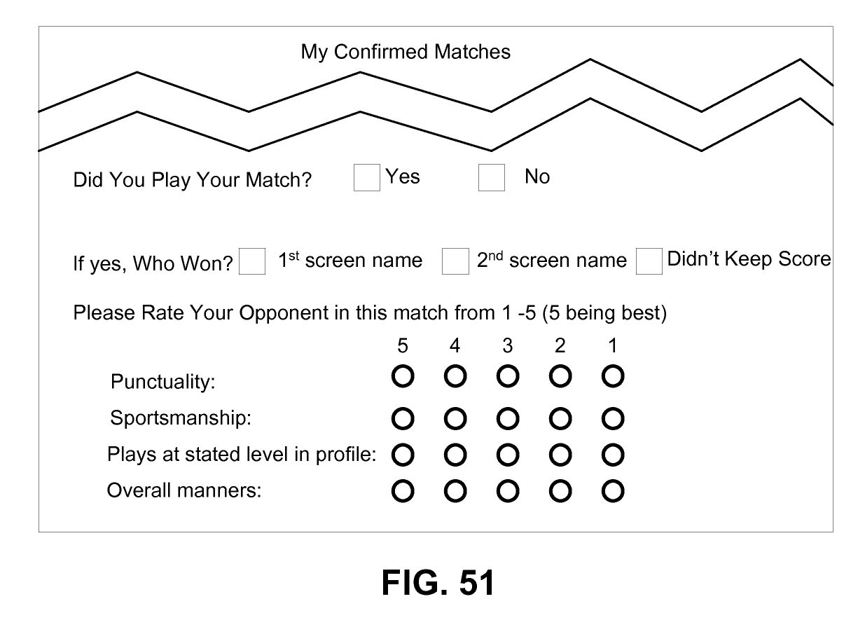

FIG. 51 shows an example of a Match History feature of the My Confirmed Matches heading according to a preferred embodiment of the present invention. The “My Played Matches” heading is populated with data as follows. One day after each confirmed match time period, a series of follow-up questions appear under the match details in the “My Confirmed Matches” heading. The follow-up questions ask whether the match was played, as shown. If the match was not played, and the “No” checkbox is chosen, all further questions do not require answers and are removed from the screen. If “Yes” is chosen, further questions are provided for input by the registered user. The system asks for the winner of the match or if score was even kept, as shown. In some sport events or social events score may not be kept. The system further asks registered users to rate their opponents in at least the following areas: punctuality, sportsmanship, plays at stated level in profile, and overall manners, as shown. As shown in FIG. 51, a 1-5 scales is used to rate your opponent.

Upon answering all of the questions, the questionnaire and the match details are removed from the “My Confirmed Matches” column. The gathered data is then displayed in “Play History” (who each registered user played, when, what sport, etc.) and “Confirmed Wins” (displayed when both match participants report the same winner in competitive sports) on each members Matches page.

Each Registered User has the option of hiding that registered user's Confirmed Wins statistics from the view of other users. Each player cannot hide the ratings relating to punctuality, sportsmanship, etc., described above. This allows all Registered Users to check one another's overall punctuality, sportsmanship, stated level accuracy, manners rating, etc. This feature is useful since users who misbehave or are not accurate about their playing ability will not get future match play requests making the Web site a reliable one. Further, knowing that users will be rated may keep them on their best behavior.

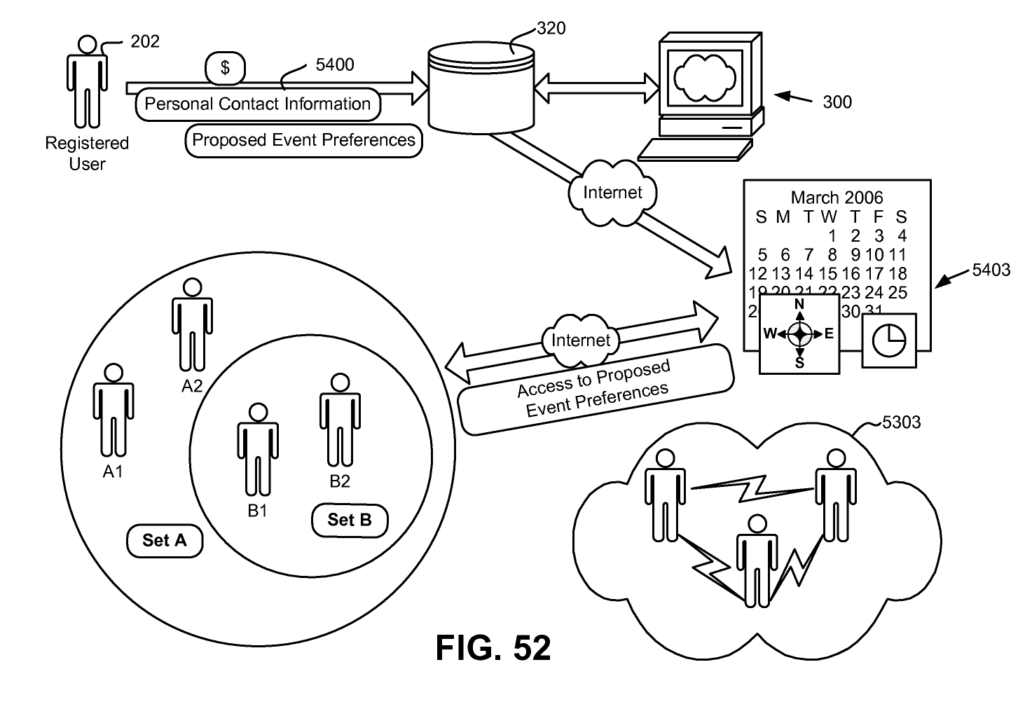

FIG. 52 shows a simplified diagrammatic overview illustrating, in a simplified form, features of Matchmaker Web site 300 according to the preferred embodiment of the present invention. As previously stated, registered user 202 preferably pays a fee for access to Matchmaker web site 300, as shown. Upon accessing Matchmaker web site 300, registered user 202 preferably uploads personal contact information 5400 to Matchmaker website 300 which is stored on the Matchmaker web site database 320. Registered user 202 also preferably enters, into a form available on Matchmaker web site 300 (see FIG. 47), proposed event preferences for unconfirmed, unscheduled proposed events (depicted as calendar, compass, clock arrangement 5403) for storage on Matchmaker web site database 320. As is indicated and shown on FIG. 47, a highly preferred combination of data fields for preferred event preferences comprises the following: preferred event (such as a sport), preferred start date, preferred start time, preferred end date, preferred end time, preferred location, preferred match type (single or group-type event), as shown. Also preferably, other data fields may be used to narrow the group of registered users with which a particular registered user may choose to associate. In this instance, the following data fields are preferred: gender, age range, marital status, occupation(s), special circumstances or disabilities, and general listing of the days of the week that a registered user is able or willing to participate in a proposed event.

Also, as is shown in FIG. 52, registered user 202 may select a set of registered users among which to share proposed event preferences. For illustrative purposes, FIG. 52 shows two sets of potential participant groups. Set A comprises User A1, User A2, User B1, and User B2. Set B comprises User B1 and User B2. Matchmaker web site 300 provides registered users with the ability to invite and associate a selected set of users (either the entire set of registered users or a selected subset of the entire set of registered users) with one or more other registered users (this feature is referred to previously herein and is also shown in the figures as the Player's Network, see FIG. 45 and FIG. 46). As shown on FIG. 45 and FIG. 46, a registered user uses Matchmaker web site 300 to communicate, preferably by sending messages to other registered users, requests, also called invitations, to join a member's preferred set of registered users. The invited users may then approve or deny the invitation. With reference to FIG. 45, a screen of Matchmaker web site 300 is shown displaying a hyperlink to the personal profile of the inviting registered user. The screen shown in FIG. 45 also shows hyperlinks that, when clicked and followed, give an invitee/registered user the ability to accept or deny the invitation. This feature is shown in FIG. 46 where a checkbox may be selected to accept or deny an invitation. Matchmaker web site 300 also permits a user to view those registered members which have been selected for inclusion within the Player's Network, the selected set of members, of a registered user. Once in a Player's Network, the members of the Player's Network will have access to unscheduled, unconfirmed proposed events 5403, which may also be referred to as Match Requests (see, e.g., FIG. 47).

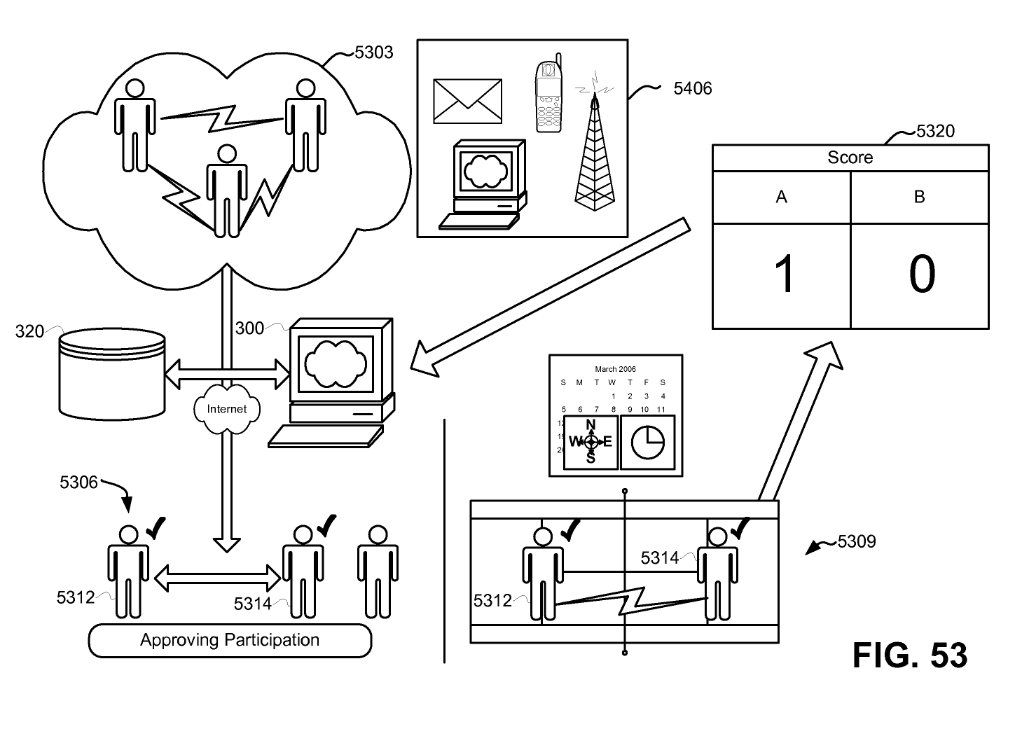

Matchmaker web site 300 further provides the ability for registered user 202 to be notified of match requests submitted by the registered users of a particular selected set. Such notification may be provided with communication tools 5406 (see FIG. 53), preferably, Matchmaker web site 300, email, or SMS/text messaging to mobile telephones.

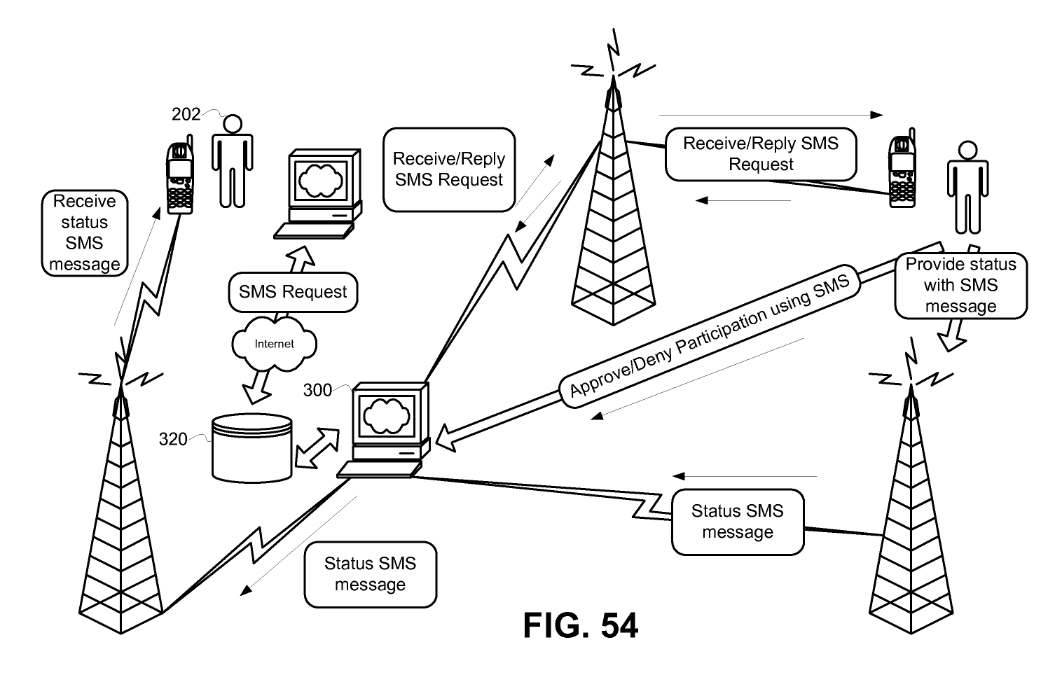

Upon submission of proposed event preferences by at least one registered user 202 to a Player's Network, those proposed event preferences may be approved by another registered user so as to form confirmed, scheduled event 5300. Matchmaker website 300 provides the ability for registered users 202 to communicate with one another (such step of communicating is depicted as communication cloud 5303), as shown in FIG. 52. Approved participant 5312 and approved participant 5314 are shown in FIG. 54 to illustrate such approval event.

FIG. 53 shows another simplified diagrammatic overview illustrating other features of Matchmaker Web site 300 according to the preferred embodiment of the present invention. More particularly, FIG. 53 further illustrates the approval process (such step of approving illustrated as approval step 5306) for confirming and scheduling proposed events among registered users of a Player's Network. After an unscheduled, unconfirmed proposed event is displayed to a Player's Network, registered users 202 are presented with the option of approving or denying participation in a presented unscheduled, unconfirmed proposed event (such unscheduled, unconfirmed proposed event is typically displayed to a registered user by way of Matchmaker web site 300 or by way of SMS messaging). As shown in FIG. 53, registered users preferably communicate through the Matchmaker web site 300. The goal of the presentation of proposed events and providing approval is that at least two registered users will approve and confirm participation in a proposed event. Matchmaker web site 300 automates the confirmation process as well as scheduling aspects of a proposed event so the proposed event may occur at a particular date, time, and location. FIG. 48 illustrates the ability of registered users to communicate within Matchmaker website 300 using the internal email messaging of Matchmaker web site 300. The internal email messaging system provides a registered user with the ability to read several match requests and approve or deny participation in that match request. With reference to FIG. 49, Matchmaker website 300 provides registered users with the ability to display to a selected set of registered users event-availability. Also shown is a data field wherein a registered user may input a maximum number of participants which may join a particular event. In operation, preferably, registered user 202 clicks on an approval hyperlink, shown and embodied in FIG. 49 with the displayed text “join this match now”, to communicate to an inviter that a participant is confirmed for the event. Upon the clicking event, Matchmaker website 300 automatically performs the necessary updating of Matchmaker database 320 and communicates the approved confirmation to the inviting registered user. Further, the event is scheduled and displayed on the participating members personal profile pages (see, e.g., FIG. 50, “My Confirmed Matches”). The display of confirmed events is for the benefit of the participating member's personal time scheduling purposes.

Preferably, registered users participating in an event will meet and participate in the event, for example, a game of tennis, at a scheduled and confirmed time, date, and location based on the initial proposed event of a registered user (this arrangement of steps referred to as participating in event 5309).

After a period of time has elapsed from the date of confirmed, scheduled event 5300, and upon a registered user visiting Matchmaker web site 300, Matchmaker website 300 provides a registered user with the ability to input data relating to the now-elapsed event into a form (see FIG. 51) which will be stored on Matchmaker database 320. In operation, a form is submitted to a registered user for data input (see FIG. 51) to gather data relating to the now-elapsed event (data 5320). Data 5320 may be the score, details of the event, behavioral characteristics of the participating member, etc. A registered user preferably enters requested data into the form. The requested data preferably comprises score, a notation whether or not the proposed event went as scheduled, and other behavioral-related questions or selections to rate the behavioral appropriateness of at least one other registered user who attended the event. The gathered data is then submitted to Matchmaker website 300 and stored for historical purposes. Reports relating to particular registered users may be generated and displayed by Matchmaker website 300 for the benefit of registered users and of a web site manager.

Also shown in FIG. 53, various communication mediums are available for registered users to communicate using Matchmaker website 300. Preferably, registered users 202 of Matchmaker website 300 may use email messaging provided by Matchmaker website 300 or short messaging service (SMS) messaging, also referred to as text messaging, coupled though Matchmaker website 300 (see FIG. 54).

FIG. 54 shows a simplified diagrammatic overview illustrating, generally, methods of communicating among registered users of Matchmaker Web site 300 according to the preferred embodiment of the present invention. As shown in FIG. 54, Matchmaker web site 300 provides a registered user with the ability to send a match request to another registered user using Matchmaker web site 300 wherein the match request is delivered to another registered user by SMS messaging (which will typically be delivered to a compatible mobile telephone or other device used by the another registered user), as shown. In operation, registered user 202 preferably accesses the SMS messaging features of Matchmaker website 300. FIG. 46 shows a checkbox selection where a registered user may enable sending of Match Requests by email or SMS messaging. To use the mobile phone/SMS messaging features of Matchmaker website 300, a registered user must provide the registered user's mobile telephone number. Internet protocol (IP) hardware and software (which may comprises service providers, modems, telecommunication routers, SMS messaging servers and related software, etc.) and services provided by telephony companies are set up to enable mobile telephone communication with Matchmaker database 320.

Upon making a proposed event preference or match request, an SMS message may be sent by way of the Internet using Matchmaker website 300. The SMS message is preferably delivered with an installed IP telecommunications systems so that the SMS message is delivered to a particular registered user. That registered user, the recipient of the SMS message, may respond to, approve or deny participation in a proposed event by replying to the sender of the text message (the SMS messaging system) by typing a particular word and sending a reply SMS message. Preferably, web site developer makes arrangements with IP and telecommunications/telephony service providers to have particular SMS message replies activate or update certain data on Matchmaker website 300 or relay a reply messages to the first sender. As an illustration, a registered user who wants to join a match request may reply to the SMS message sender with the word “JOIN”. Such message will subsequently be delivered through telecommunications systems and Matchmaker web site 300 to the desired registered user. Preferably, Matchmaker database 320 is updated accordingly.

Matchmaker website 300 may further provide communication among registered users who are en route to a proposed event location. Further, Matchmaker website 300 may perform this communication in an anonymous fashion. In operation, registered user 202 either using Matchmaker website 300 (through a desktop computer, laptop computer, or Internet enabled mobile phone) may request that an SMS message be sent to another particular registered user requesting a status update (distance to proposed event location, etc.). The SMS message is preferably delivered over IP telecommunications systems coupled to Matchmaker website 300. Because communication occurs by way of Matchmaker website 300, there is no need to disclose personal contact information, such as mobile telephone numbers, to other registered users. In this way registered users may communicate with one another anonymously, until a time when a registered user feels comfortable disclosing personal information.

Although applicant has described applicant's preferred embodiments of this invention, it will be understood that the broadest scope of this invention includes modifications. Such scope is limited only by the below claims as read in connection with the above specification.

Further, many other advantages of applicant's invention will be apparent to those skilled in the art from the above descriptions and the below claims.

What is claimed is:

1) A method, relating to providing at least one unconfirmed, unscheduled proposed-event preference of at least one registered user, among a network of registered users of at least one Internet web site resulting in at least one confirmed, scheduled event, said method comprising the steps of:
a) providing storage of personal contact information of a plurality of registered users of the Internet web site;
b) providing storage of at least one unconfirmed, unscheduled proposed-event preference for at least one first registered user of the Internet web site;
c) providing communicating such at least one unconfirmed, unscheduled proposed-event preference to at least one first registered-user-selected set of the plurality of registered users of the Internet web site;
d) providing communicating participation interest in the at least one preferred, unconfirmed, and unscheduled proposed-event by at least one member of the at least one first registered-user-selected set to at least one other member of the at least one registered-user-selected set;
e) providing approving interest by the at least one other member in participating in the at least one preferred, unconfirmed, unscheduled proposed-event;
f) providing automatically scheduling and storing the at least one now-approved, confirmed, scheduled event; and
g) providing automatically communicating details of such now confirmed, scheduled event to the at least one other member approving participation, the “approved participants”.

2) The method, according to claim 1, wherein such step of communicating details of such now confirmed, scheduled event to approved participants comprises the step of displaying, for the benefit of at least one of the approved participants, details of the now confirmed, scheduled event.

3) The method, according to claim 1, wherein such step of providing approving interest in participating in the at least one preferred, unconfirmed, unscheduled proposed-event by the communicating registered users comprises the step of providing notifying approval among registered users by way of at least one email message delivered by way of the Internet.

4) The method, according to claim 1, wherein such step of providing approving interest in participating in the at least one preferred, unconfirmed, unscheduled proposed-event by the communicating registered users comprises the step of providing notifying approval among registered users by way of at least SMS message delivered over at least one telecommunications network.

5) The method, according to claim 1, wherein such step of automatically communicating details of such now confirmed, scheduled event to approved participants comprises providing communicating such details by way of at least one email message delivered by way of the Internet.

6) The method, according to claim 1, wherein such step of communicating details of such now confirmed, scheduled event to approved participants comprises the step of providing communicating such details by way of at least SMS message over at least one telecommunications network.

7) The method, according to claim 1, further comprising the step of providing displaying elapsed confirmed, scheduled event after a date when such confirmed, scheduled event was intended to occur,

8) The method, according to claim 1, further comprising the step of providing limiting a number of approved participants that may participate in the at least one preferred, unconfirmed, unscheduled proposed-event.

9) The method, according to claim 8, further comprising the step of providing displaying, for the benefit of at least one registered user, at least one quantity of remaining approved participant openings relating to a particular registered-user proposed limit of a number of approved participants that may participate in the at least one preferred, unconfirmed, unscheduled proposed-event.

10) The method, according to claim 1, further comprising the step of providing displaying, for the benefit of at least one registered user, approved personal contact information of at least one confirmed participant that may participate in the now confirmed, scheduled event so that the confirmed registered users may further communicate regarding the now confirmed, scheduled event.

11) The method, according to claim 1, further comprising the step of providing assisting non-disclosure of contact information of at least one first participant to another participant; and providing assisting non-disclosure of contact information of such at least one second participant to such first participant.

12) The method, according to claim 1, further comprising the step of providing gathering data relating to the confirmed, scheduled event from participants of the confirmed, schedule event after the date when such confirmed, scheduled event was intended to occur has elapsed.

13) The computer program system, according to claim 4, wherein such SMS messaging is assisted by coupling through at least one Internet Web site.

14) The computer program system, according to claim 6, wherein such SMS messaging is assisted by coupling through at least one Internet Web site.

15) The computer program system, according to claim 1, wherein the step of providing approving interest by the at least one other member in participating in the at least one preferred, unconfirmed, unscheduled proposed-event comprises providing displaying at least one clickable hyperlink that when clicked once communicates approved interest to registered users of the at least one Internet web site.

16) The computer program system, according to claim 12, wherein the step of providing gathering data relating to the confirmed, scheduled event from participants of the confirmed, schedule event after the date when such confirmed, scheduled event was intended to occur has elapsed comprises the step of providing assisting input from participants of the confirmed, schedule event concerning behavioral profiling of at least one of the participants.

17) The computer program system, according to claim 16, further comprising the step of assisting compiling statistical data concerning such behavioral profiling of each of at least one of the participants.

18) The computer program system, according to claim 17, further comprising the step of assisting anonymous display of such statistical data.

19) The computer program system, according to claim 18, further comprising the step of providing displaying of such statistical data coupled to each participants profile page data.

20) A method, relating to providing at least one unconfirmed, unscheduled proposed-event preference of at least one registered user, among a network of registered users of at least one Internet web site resulting in at least one confirmed, scheduled event, said method comprising the steps of:
a) providing storage of personal contact information of a plurality of registered users of the Internet web site;
b) providing storage of at least one unconfirmed, unscheduled proposed-event preference for at least one first registered user of the Internet web site;
c) providing communicating such at least one unconfirmed, unscheduled proposed-event preference to at least one first registered-user-selected set of the plurality of registered users of the Internet web site;
d) providing communicating participation interest in the at least one preferred, unconfirmed, and unscheduled proposed-event by at least one member of the at least one first registered-user-selected set to at least one other member of the at least one registered-user-selected set;
e) providing approving interest by the at least one other member in participating in the at least one preferred, unconfirmed, unscheduled proposed-event;
f) providing automatically scheduling and storing the at least one now-approved, confirmed, scheduled event; and
g) providing automatically communicating details of such now confirmed, scheduled event to the at least one other member approving participation, the “approved participants”;
h) wherein such unscheduled proposed-event preference is sports related.

21) The method, according to claim 20, wherein such unscheduled proposed-event preference is sports team related.
